(19) United States
(12) Patent Application Publication
(10) Pub. No.: US 2016/0275487 A1
(43) Pub. Date: Sep. 22, 2016

(54) DEVICE, SYSTEM, AND METHOD FOR CREATING VIRTUAL CREDIT CARD

(71) Applicant: Tencent Technology (Shenzhen) Company Limited, Shenzhen (CN)

(72) Inventors: Guoguo LIU, Shenzhen (CN); Yi WU, Shenzhen (CN); Chen GONG, Shenzhen (CN); Wenjing ZHANG, Shenzhen (CN); Jinming ZHANG, Shenzhen (CN); Jinwen TAN, Shenzhen (CN); Yixin GUO, Shenzhen (CN); Wa YE, Shenzhen (CN); Liang HOU, Shenzhen (CN); Zhenyu XU, Shenzhen (CN); Bin ZHANG, Shenzhen (CN); Wei CHEN, Shenzhen (CN); Haojian ZHENG, Shenzhen (CN); Yingyi JIANG, Shenzhen (CN); Lingyun SONG, Shenzhen (CN); Nan JIANG, Shenzhen (CN)

(73) Assignee: Tencent Technology (Shenzhen) Company Limited, Shenzhen (CN)

(21) Appl. No.: 15/171,485

(22) Filed: Jun. 2, 2016

Related U.S. Application Data
(63) Continuation of application No. PCT/CN2015/070168, filed on Jan. 6, 2015.

(30) Foreign Application Priority Data
Mar. 13, 2014 (CN) 201410093726.4

(51) Int. Cl. G06Q 20/34; G06F 3/0481; G06Q 20/36; G06F 17/30; G06Q 20/40; G06Q 20/10

(52) U.S. Cl. CPC G06Q 20/351; G06Q 20/40; G06Q 20/102; G06Q 20/363; G06F 17/30864; G06F 3/0481

(57) ABSTRACT

The present disclosure directs to method, device, system for creating virtual credit card. The method includes: receiving a subset of real-name information from a user interface of a terminal device; searching the real-name information stored in the first server with the subset of the real-name information; upon the real-name information is found, sending the real-name information to the second server; finding whether the real-name information associates with a credit card account; after finding the credit card account is not stored in the second server, determining whether an exchange resource account tying to the electronic exchange account is stored in the first server; if the exchange resource account is not stored, receiving account information of a resource saving account, and binding the electronic exchange account and the resource saving account; creating a virtual credit card account by the second server; and storing the virtual credit card in the first server.

This application is a national phase application out of PCT Application No. PCT/CN2015/070168, filed on Jan. 6, 2015, which claims priority to Chinese Patent Application No. 201410093726.4, filed on Mar. 13, 2014, both of which are hereby incorporated by reference in their entirety.

### FIELD OF THE TECHNOLOGY

The present disclosure relates to the technology of data-processing, particularly to the data processing technology of a device, a system and a method for creating virtual credit card.

### BACKGROUND OF THE TECHNOLOGY

The credit card may be created and managed by the corresponding management server. Credit card users may use the credit card to make purchases and transfer funds from between credit card account and the savings accounts. The credit card typically has a physical form and the credit card may associate with a bank.

### SUMMARY OF THE TECHNOLOGY

A device, a system and a method for creating a virtual credit card are provided with examples of the present disclosure. The virtual credit card may not have a physical form of the credit card and the use and creation of the virtual credit card may not associate with the bank only. After the creation of the virtual credit card, the virtual credit card may be used and saved at a third party other than the bank.

The example for the device for creating virtual credit card. The device includes a first server having a data storage containing real-name information associated with an electronic exchange account; wherein the first server is configured to:

Receive a subset of real-name information from a user interface of a terminal device wherein the subset of the real-name information includes at least a portion of a user name or user identification number, wherein the portion is associated with the electronic exchange account;

Search for the real-name information stored in the data storage using the received subset of the real-name information; send the real-name information found in the data storage to the second server for use in finding an associated credit card account stored in the second server;

Receive a credit indicator from the second server if the credit card account is not stored in the second server; determine, upon receipt of the credit indicator, whether an exchange resource account associated with the electronic exchange account is stored in the data storage;

Send, upon receipt of a determination that the exchange resource account is not stored in the data storage, a binding instruction to the user interface of the terminal device; receive, according to the binding instruction, account information of a resource saving account from the user interface of the terminal device; store the account information to the data storage; bind the electronic exchange account and the resource saving account; send a binding result to the second server;

Receive information associated with a virtual credit card account created by the second sever after receiving the binding result; and store the virtual credit card associated with the virtual credit card account in the data storage of the first server.

The example of the present disclosure provides a system for creating virtual credit card to be stored in a data storage. The system includes a first server having the data storage, a terminal device having a user interface communicating to the first server, and a second server communicating to the first server.

The terminal device of the system is configured to: receive a subset of real-name information from a user interface, wherein the subset of the real-name information comprises at least a portion of: a user name or a user identification number, wherein the portion is associated with an electronic exchange account stored in the data storage of the first server.

The first server of the system is configured to: receive the subset of the real-name information from the terminal device, search the real-name information stored in the data storage with the subset of the real-name information, wherein the real-name information is pre-stored in the data storage; upon the real-name information is found in the first server, send the real-name information from the first server to the second server.

The second server is configured to: upon the receipt of the real-name information, find whether the real-name information associates with a credit card account that is stored in the second server, after finding the credit card account is not stored in the second server, sending a credit indicator from the second server to the first server.

The first server is further configured to: after receiving the credit indicator, determine whether an exchange resource account tying to the electronic exchange account is stored in the data storage; if the exchange resource account tying the electronic exchange account is not stored in the data storage, send a binding instruction to the user interface of the terminal device.

The terminal device is configured to: according to the binding instruction, receive account information of a resource saving account from the user interface, and send the account information to the first server.

The first server is configured to: receive the account information of the resource saving account, and store the account information in the data storage, bind the electronic exchange account and the resource saving account, and send a binding result that results from binding the electronic exchange account and the resource saving account to the second server.

The second server is further configured to: receive the binding result from the first sever, and create a virtual credit card account; and the first server is configured to: store the virtual credit card associated with the virtual credit card account in the data storage of the first server.

The example for a method for creating a virtual credit card to be stored in a data storage includes steps of: receiving a subset of real-name information from a user interface by a terminal device, wherein the subset of the real-name information comprises at least a portion of: a user name or a user identification number, wherein the portion is associated with an electronic exchange account stored in the data storage of a first server; receiving, by the first server, the subset of the real-name information; searching the real-name information stored in the first server with the subset of the real-name information, wherein the real-name information is pre-stored in the data storage of the first server; upon the real-name information is found in the first server, sending the real-name information from the first server to the second server, and finding, by the second server, whether the real-name information associates with a credit card account stored in the second server; after finding the credit card account is not stored in the second server, sending a credit indicator from the second server to the first server; determining, by the first server, whether an exchange resource account tying to the electronic exchange account is stored in the first server after the credit indicator is received by the first server.

If the exchange resource account tying to the electronic exchange account is not stored in the first server, the method further includes: sending, by the first server, a binding instruction to the user interface of the terminal device; according to the binding instruction, receiving account information of a resource saving account from the user interface of the terminal device, and sending, by the terminal device, the account information to the first server; receiving, by the first server, the account information of the resource saving account, and storing the account information in the first server, binding the electronic exchange account and the resource saving account, and sending a binding result that results from binding the electronic exchange account and the resource saving account to the second server; receiving, by the second server, the binding result from the first sever, and creating a virtual credit card account; and storing the virtual credit card associated with the virtual credit card account in the data storage of the first server.

### BRIEF DESCRIPTION OF THE DRAWINGS

To describe the technical solutions in the examples of the present disclosure more clearly, the following briefly introduces the accompanying drawings needed for describing the examples or the prior art. Apparently, the accompanying drawings in the following description show some examples of the present disclosure, and persons of ordinary skill in the art may still derive other drawings from these accompanying drawings without creative efforts.

The system and/or method may be better understood with reference to the following drawings and description. Non-limiting and non-exhaustive descriptions are described with reference to the following drawings. The components in the FIG.s are not necessarily to scale, emphasis instead being placed upon illustrating principles. In the FIG.s, like referenced numerals may refer to like parts throughout the different FIG.s unless otherwise specified.

FIG. 1 is a structure schematic showing implementing environment for each example of the present disclosure;

FIG. 2 is a method flow chart showing a method for creating virtual credit card account according to an example of present disclosure;

FIG. 3A is a method flow chart showing a method for creating virtual credit card account according to another example of present disclosure;

FIG. 3B is an interface schematic showing about acquiring subset of real-name information according to the example of present disclosure;

FIG. 3C is an interface schematic showing about acquiring account information according to the example of present disclosure;

FIG. 3D is an interface schematic showing a typical validation interface according to the example of present disclosure;

FIG. 3E is interface schematics showing the virtual credit card account during and after validation according to the example of present disclosure;

FIG. 3F is an interface schematic showing the binding result according to the example of present disclosure;

FIG. 3G is an interface schematic showing an entry of increasing credit limit according to the example of present disclosure;

FIG. 3H is a method flow chart showing a method for creating virtual credit card account according to the example of present disclosure;

FIG. 4 is a frame diagram showing a device for creating virtual credit card account according to an example of present disclosure;

FIG. 5 is a frame diagram showing a device for creating virtual credit card account according to another example of present disclosure;

FIG. 6 is a frame diagram showing a device for creating virtual credit card account according to an example of present disclosure;

FIG. 7 is a frame diagram showing a device for creating virtual credit card account according to another example of present disclosure;

FIG. 8 is a frame diagram showing a device for creating virtual credit card account according to an example of present disclosure;

FIG. 9 is a frame diagram showing a device for creating virtual credit card account according to another example of present disclosure;

FIG. 10 is a frame diagram showing a system for creating virtual credit card account according to the example of present disclosure;

FIG. 11 is a frame diagram showing a terminal according to the example of present disclosure; and

FIG. 12 is a frame diagram showing a server according to the example of present disclosure;

### DETAILED DESCRIPTION

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one example,” “an example,” “examples,” “one embodiment,” “an embodiment,” “example embodiment,” or the like in the singular or plural means that one or more particular features, structures, or characteristics described in connection with an embodiment or an example is included in at least one embodiment or one example of the present disclosure. Thus, the appearances of the phrases “in one embodiment,” “in an embodiment,” “in an example embodiment,” “in one example,” “in an example,” or the like in the singular or plural in various places throughout this specification are not necessarily all referring to the same embodiment. Furthermore, the particular features, structures, or characteristics may be combined in any suitable manner in one or more embodiments or examples.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the terms “module,” “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a terminal device, and a communication network. The server and the terminal device may be coupled through the communication network for information exchange, such as sending/receiving identification information, sending/receiving data files such as splash screen images, etc. Although only one terminal device and one server are shown in the environment, any number of terminals or servers may be included, and other devices may also be included.

The communication network may include any appropriate type of communication network for providing network connections to the server and terminal device or among multiple servers or terminal devices. For example, communication network may include the Internet or other types of computer networks or telecommunication networks, either wired or wireless. In a certain embodiment, the disclosed methods and apparatus may be implemented, for example, in a wireless network that includes at least one terminal device.

In some cases, the terminal device or the device may refer to any appropriate user terminal with certain computing capabilities, such as a personal computer (PC), a work station computer, a server computer, a hand-held computing device (tablet), a smart phone or mobile phone, or any other user-side computing device. In various embodiments, the terminal device may include a network access device. The terminal device may be stationary or mobile.

A server, as used herein, may refer to one or more server computers configured to provide certain server functionalities, such as database management and search engines. A server may also include one or more processors to execute computer programs in parallel.

It should be noticed that, the embodiments/examples and the features in the embodiments/examples may be combined with each other in a no conflict condition. This invention will become apparent from the following detailed description when taken in conjunction with the accompanying drawings.

It should be noticed that, the steps illustrated in the flowchart of the drawings may be performed in a set of computer device with executable program codes. And the order of the steps may be different from that in the drawings under some status, although a logic order is shown in the flowchart.

The purpose, technical proposal and advantages in the examples of the present disclosure will become more clear and complete from the following detailed description when taken in conjunction with the appended drawings. Apparently, the examples described thereinafter are merely a part of examples of the present disclosure, not all examples. Persons skilled in the art may obtain all other examples without creative works, based on these examples, which pertains to the protection scope of the present disclosure.

An existing method for creating credit card account includes: the account management server receives a request for creating credit card account of a user which is triggered in the page, according to the request for creating virtual credit card account, an information input box is displayed to the user in the page, with the information input box used for entering the name, ID number, address, email and phone number, and other user information. Then, the account management server receives user information which is input into the corresponding input box, and provides the user information to staff for validation.

When the user receives the feedback information from the staff indicating that the validation is passed; the account management server create a new credit card account based on the user information and generates the corresponding real credit card. Finally, the staff will mail the real credit card corresponding to the credit card account, so that user could use the credit card account by the credit card in the subsequent course.

A device, a system and a method for creating a virtual credit card are provided with examples of the present disclosure. The virtual card creation may only require the input of a subset of user information. The virtual credit card may not have a physical form of the credit card and may be used the same way as the credit card with the same form. In addition, the virtual credit card may be created and saved at a reliable party other than a bank. The virtual credit card account may refer to the account that is created for the virtual credit card. The virtual credit card account and the virtual credit card may be used exchangeably under some circumstances. In the following disclosure, the first server may refer to one or more processing servers that are operated by a third party other than a bank, the second server may be operated by a bank. The terminal device refers to any user device that may have a user interface to allow a user to enter into information for applying for a credit card. The present disclosure provides method, device, system for creating virtual credit card, and the technical solution is described hereinafter:

In the first aspect, the present disclosure provides a device for creating virtual credit card, which is set in a first server, which includes:

A first receiving module, configured to receive a subset of real-name information sent by a terminal device, with the subset of real-name information acquired by the terminal device being corresponding to a user who has opened an electronic exchange account;

A first sending module, configured to send real-name user information that matches the subset of real-name information which is received by the first receiving module to a second server, with the real-name user information being configured to trigger the second server send an indicator indicating no said credit card account exists to the first server, after detecting there is no credit card account exists to correspond to the real-name user information, and the real-name user information being saved in the first server;

An account detecting module, configured to receive said indicator, and detect whether there is an exchange resource account binding to said electronic exchange account;

An instruction sending module, configured to send a binding instruction to the terminal device after detecting that there is no exchange resource account binding to said electronic exchange account, allowing the terminal device to acquire and send an account information of a resource saving account to the first server directed by the binding instruction;

A first binding module, configured to receive the account information of resource saving account sent by the instruction sending module, and bind the electronic exchange account and the resource saving account together; and

A second sending module, configured to send the binding result that results from binding the electronic exchange account and the resource saving account together by the first binding module to the second server, with said binding result triggering the second server to create a virtual credit card account of said user.

In the second aspect, the present disclosure provides a device for creating virtual credit card account, which is set in a terminal device, which includes:

A first acquiring module, configured to acquire and send the subset of real-name information of a user who has opened an electronic exchange account to the first server, with the subset of real-name information is configured to trigger the first server to send a real-name user information that matches the subset of real-name information to a second server, with the real-name user information being configured to trigger the second server to send an indicator indicating no said credit card account exists to the first server, after detecting there is no credit card account exists to correspond to the real-name user information, the indicator is configured to trigger the first server to send a binding instruction to the terminal device after detecting that there is no exchange resource account binding to said electronic exchange account, and the real-name user information being saved in the first server;

A first receiving module, configured to receive the binding instruction from the first server according to the subset of real-name information sent by the first acquiring module, and acquire the account information of resource saving account under the binding instruction; and

A first sending module, configured to send the account information of resource saving account received by the first receiving module to the first server, with the account information of resource saving account triggering first server to bind the electronic exchange account and the resource saving account together, and send the binding result of the electronic exchange account and the resource saving account to the second server, and the binding result that results from binding the electronic exchange account and the resource saving account triggering the second server to create a virtual credit card account of said user.

In the third aspect, the present disclosure provides a device for creating virtual credit card account, which is set in a second server, which includes:

A first receiving module, configured to receive user real-name information which matches the subset of real-name information sent by the first server, with the subset of real-name information which is corresponding to a user who has opened an electronic exchange account being acquired by the terminal device and sent to the first server, and the real-name user information being saved in the first server;

An account detecting module, configured to detect whether there is a credit card account exists which is corresponding to the user real-name information received by the first receiving module;

A first sending module, configured send an indicator indicating no said credit card account exists to the first server, after detecting there is no credit card account exists by account detecting module, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server; and

An account creating module, configured to receive the binding result generated by binding the electronic exchange account and the resource saving account, to create a virtual credit card account of the user.

In the fourth aspect, the present disclosure provides a system for creating virtual credit card account, which includes: a first server, a terminal device communicating to the first server, and a second server communicating to the first server;

The first server includes a device for creating virtual credit card account as described in the first aspect, said terminal device comprises a device for creating virtual credit card account as described in the second aspect, and said second server comprises a device for creating virtual credit card account as described in the third aspect.

In the fifth aspect, the present disclosure provides a method for creating virtual credit card account, which includes:

Acquiring subset of real-name information which is corresponding to a user who has opened an electronic exchange account, and sending subset of real-name information to a first server by a terminal device;

Receiving the subset of real-name information, and sending real-name user information which matches the subset of real-name information to a second server by the first server, with the real-name user information being saved in the first server;

Receiving the real-name user information by the second server, and detecting whether there is a credit card account exists to correspond to the real-name user information, if no, sending an indicator indicating no said credit card account exists to the first server; and

Receiving the indicator by the first server, and detecting whether there is an exchange resource account binding to said electronic exchange account, if there is no exchange resource account binding to said electronic exchange account, sending a binding instruction to the terminal device;

Receiving the binding instruction by the terminal device, and acquiring and sending account information of a resource saving account to the first server directed by the binding instruction;

Receiving account information of the resource saving account by the first server, binding the electronic exchange account and the resource saving account together, and sending the binding result that results from binding the electronic exchange account and the resource saving account together to the second server; and

Receiving the binding result that results from binding the electronic exchange account and the resource saving account together by the second server, to create a virtual credit card account of said user.

In the sixth aspect, the present disclosure provides a method for creating virtual credit card account which is employed by a first server, and the method includes:

Receiving subset of real-name information which is corresponding to a user who has opened an electronic exchange account being acquired by the terminal device;

Sending the user real-name information which matches to the subset of real-name information to a second server, with the real-name user information being configured to trigger the second server send an indicator indicating no said credit card account exists to the first server, after detecting there is no credit card account exists to correspond to the real-name user information, and the real-name user information being saved in the first server;

Receiving the indicator, and detecting there is an exchange resource account binding to said electronic exchange account;

If detecting that there is no exchange resource account binding to said electronic exchange account, sending a binding instruction to the terminal device, allowing the terminal device to acquire and send an account information of a resource saving account to the first server directed by the binding instruction;

Receiving the account information of resource saving account, and binding the electronic exchange account and the resource saving account together; and

Sending the binding result that results from binding the electronic exchange account and the resource saving account together to the second server, with said binding result triggering the second server to create a virtual credit card account of said user.

In the seventh aspect, the present disclosure provides a method for creating virtual credit card account which is employed by a terminal device, and the method includes:

Acquiring and sending the subset of real-name information of a user who has opened an electronic exchange account to the first server, with the subset of real-name information is configured to trigger the first server to send a real-name user information that matches the subset of real-name information to a second server, with the real-name user information being configured to trigger the second server to send an indicator indicating no said credit card account exists to the first server after detecting there is no credit card account exists to correspond to the real-name user information, and the indicator is configured to trigger the first server to send a binding instruction to the terminal device after detecting that there is no exchange resource account binding to said electronic exchange account, and the real-name user information being saved in the first server;

Receiving the binding instruction, and acquiring the account information of resource saving account under the binding instruction; and

Sending the account information of the resource saving account received to the first server, with the account information of resource saving account triggering first server to bind the electronic exchange account and the resource saving account together, and sending the binding result of the electronic exchange account and the resource saving account to the second server, and the binding result that results from binding the electronic exchange account and the resource saving account triggering the second server to create a virtual credit card account of said user.

In the eighth aspect, the present disclosure provides a method for creating virtual credit card account which is employed by a second server, and the method includes:

Receiving user real-name information which matches the subset of real-name information sent by the first server, with the subset of real-name information which is corresponding to a user who has opened an electronic exchange account being acquired by the terminal device and sent to the first server, and the real-name user information being saved in the first server;

Detecting whether there is a credit card account exists which is corresponding to the user real-name information;

Sending an indicator indicating no said credit card account exists to the first server after detecting there is no credit card account exists, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server; and

Receiving the binding result generated by binding the electronic exchange account and the resource saving account, to create a virtual credit card account of the user.

Send an indicator indicating no said credit card account exists to the first server, after detecting there is no credit card account exists to correspond to the real-name user information; send a binding instruction to the terminal device after detecting that there is no exchange resource account binding to said electronic exchange account; the terminal device acquires the account information of a resource saving account directed by the binding instruction, and sends the account information of a resource saving account to the first server; the first server receives the account information of resource saving account, to bind the electronic exchange account and the resource saving account together, and send the binding result of the electronic exchange account and the resource saving account to the second server; and the second server receives the binding result that results from binding the electronic exchange account and the resource saving account to create a virtual credit card account of the user.

The process of creating virtual credit card account combining the electronic exchange account and the binding resource saving account, enables the second server to acquire the user real-name information according to the electronic exchange account, and determine a binding result of the electronic exchange account and the resource saving account, according to the detecting result, which may omit comprehensive collecting the user information and manual validation process, instead, it creates a virtual credit card account for user, and solves the problem of time consuming for credit card account application, long creation process and inefficient creation, therefore the efficiency on creating virtual credit card account is improved.

To make the objectives, technical solutions, and advantages of the present disclosure more comprehensible, the following describes the examples of the present disclosure in detail with reference to the accompanying drawings.

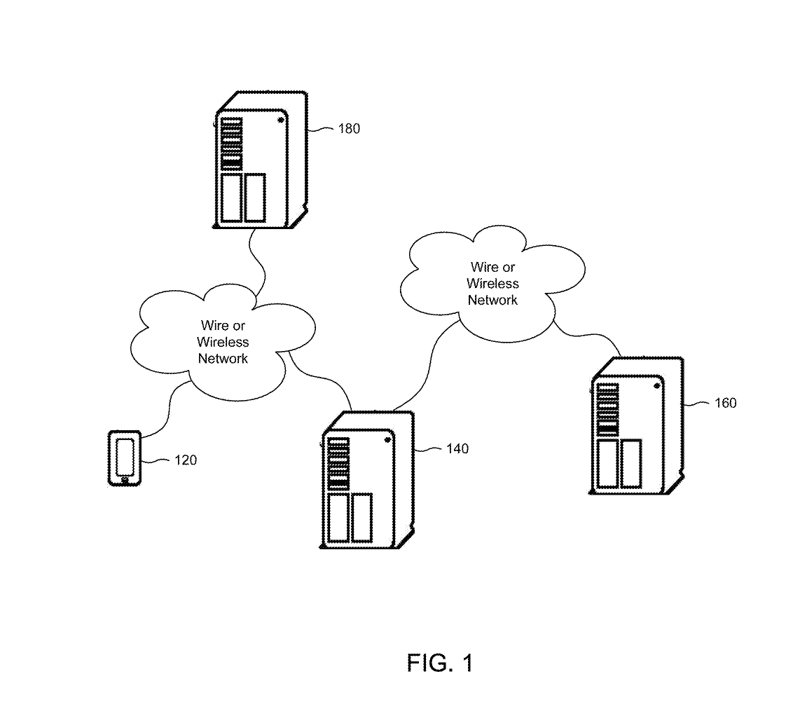

As shown in FIG. 1, it shows an implement environment related to various examples of present disclosure. The implement environment includes: a terminal 120, a first server 140 and a second server 160.

The terminal 120 may be mobile phones, tablet PCs, e-book readers, MP3 players (Moving Picture Experts Group Audio Layer III), MP4 (Moving Picture Experts Group Audio Layer IV) players, laptop computers and desktop computers, etc.

The terminal 120 on which application terminal device or browser may have been installed visits web terminal device of the application through a browser. The application terminal device and web terminal device are collectively called the terminal device in the examples of present disclosure, no special statement below.

The terminal device may be the one with electronic exchange functional terminal device, or the one simultaneously with the electronic exchange function and social function, or the one simultaneously with the electronic exchange function and game function, or the one simultaneously with electronic exchange function and email function, or the one simultaneously with electronic exchange function and financial function, or the one simultaneously with electronic exchange function and other functions like information inquiry. The electronic exchange accounts and other electronic accounts of the user are bound or associated with each other, when the terminal device is simultaneously with the electronic exchange function and other functions.

The first server 140 may be a server, or a server cluster consisting of several servers, or a cloud computing service center. The first server 140 and the terminal 120 provide businesses like electronic exchange to each other. The first server 140 is usually established by internet service providers.

The second server 160 may be a server, or server cluster consisting of several servers, or a cloud computing service center. The second server 160 is used to provide resource saving account, credit card account, and to create and manage virtual credit card account according to examples the present disclosure. The second server 160 is usually established by financial institutions, such as bank. The resource saving account is an account making the pre-stored resource as exchange resource, such as saving card account in the bank; Credit card account is an account which is overdrawn to exchange resources according to credit of the user, such as credit card account in the bank.

The terminal 120 may communicate with the first server 140 via wireless network or wired network, and the first server 140 may communicate with the second server 160 via wireless network or wired network.

When the terminal device of the terminal 120 is the terminal device simultaneously with electronic exchange function and other function, the other server 180 is used to provide corresponding types of businesses to terminal 120 reciprocally, such as social business, game business, email business, financial business, and service business for information query. The other server 180 may also be used to provide corresponding types of historical data to the first server 140 according to the example of present disclosure.

For instance, historical exchange data, historical social data, historical email data, historical financial data, and historical login data. The historical exchange data may include at least one of historical exchange number, historical exchange frequency, and historical exchange amount, and other information; historical social data may include at least one of historical online time, historical number of social people, historical speech frequency and other information; historical email data may include at least one of historical number of emails, historical size of emails, and other information; historical financial data may include historical investment amount, historical profit amount and other information; such as at least one; historical login data may include at least one of historical login number, historical login frequency, and historical online time and other information.

It should be noted first that, in various examples of present disclosure, the terms involves:

Real-name user information is mainly used to verify identity of the user who applies for creating a virtual credit card account. Real-name user information includes user name and identity document number, the identity document number is usually identity card number. In other possible cases, identity document number may also be any number which uniquely identifies user identity, just like passport number, MTPs number, or military officer number. Additionally, real-name user information usually includes the user phone number as well.

User history data is mainly used to provide a reference for the second server to determine the credit limit of the virtual credit card account of the user. User history data may include above-mentioned corresponding types of historical data of the user, and may also include the user basic personal information, such as age, date of birth, native place, education, historical schools, home address, contact address, and immediate family members, etc.

Electronic exchange account may an account used to complete electronic exchange employing the electronic exchange function provided by the user on the terminal device. Electronic exchange account possesses exchange and transfer functions, such as transferring part of the resource pre-stored in the electronic exchange account to exchange goods by the user, or transferring part of the resources from other accounts into this electronic exchange account, etc. For example, the electronic exchange account may be Wechat payment account, Paypal account, Jingdong account, or Meituan account, etc.

Other electronic accounts bound or associated with electronic exchange account may include at least one of electronic social account, electronic game account, electronic email account, electronic financial account, and electronic service account. Electronic social account is an account used to complete social function using the social function provided on the terminal device by the user, for example, electronic social account may be Wechat account, current account, Line account, etc. Electronic email account is an account used to receive and send email using the email function provided on the terminal device by the user, for example, electronic email account may be Google account, Yahoo account, Netease account, Sina account, Microsoft account, etc. Electronic financial account is an account used to complete electronic financing using the financial function provided on the terminal device by the user, for example, electronic financial account may be e-billing account, stock account, etc. Electronic service account is an account used to acquire service using information query and other service functions provided on the terminal device by the user, for example, electronic service account may be ink weather account, TigerMap account, etc.

The following describes the solutions for creating virtual credit card account in detail with reference to examples.

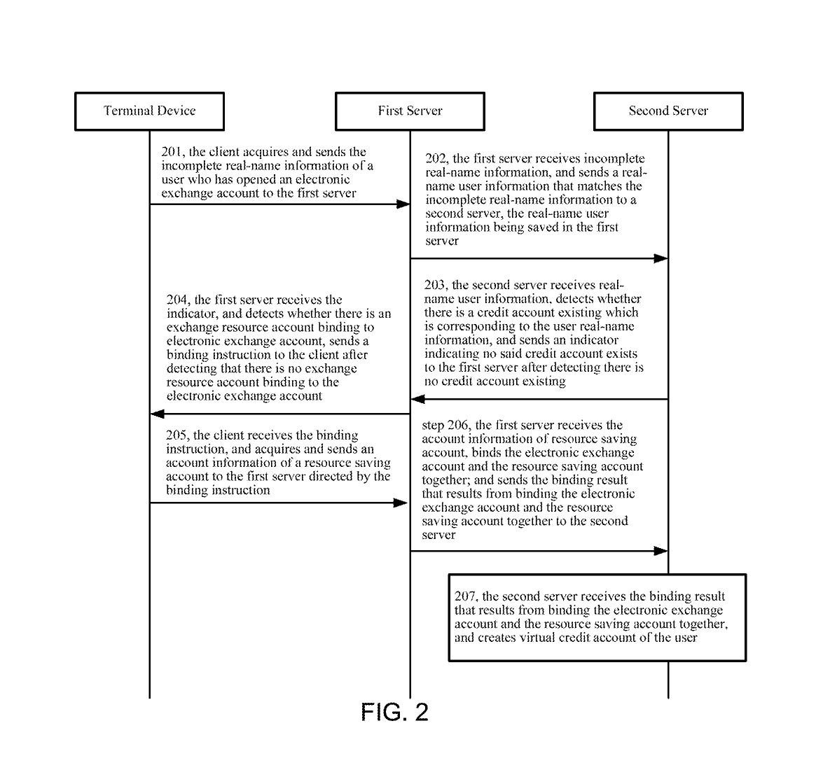

As shown in FIG. 2, it shows a flow chart of the method for creating virtual credit card account according to an example of present disclosure, the method for creating virtual credit card account, includes following steps:

In step 201, the terminal device acquires and sends the subset of real-name information of a user who has opened an electronic exchange account to the first server; and the subset of real-name information is used to match real-name user information.

In step 202, the first server receives subset of real-name information, and sends a real-name user information that matches the subset of real-name information to a second server, the real-name user information being saved or pre-stored in the first server;

In step 203, the second server receives real-name user information, detects whether there is a credit card account existing which is corresponding to the user real-name information, and sends an indicator indicating no said credit card account exists to the first server after detecting there is no credit card account existing;

Since there is no credit card account existing in the second server, therefore, the second server determines that the user is incredible, the virtual credit card account may not be created for the user in this case, and an indicator indicating no said credit card account exists is sent to the first server.

In step 204, the first server receives the indicator, and detects whether there is an exchange resource account binding to electronic exchange account, sends a binding instruction to the terminal device after detecting that there is no exchange resource account binding to the electronic exchange account; and

The first server may determine whether a user may be trusted through detecting whether there is an exchange resource account binding to electronic exchange account, wherein the exchange resource account is used to provide exchange resource by using electronic exchange account.

In step 205, the terminal device receives the binding instruction, and acquires and sends an account information of a resource saving account to the first server directed by the binding instruction;

The account information of resource saving account may include account number, account type, the server opening the resource account, and the validation terminal identity which is corresponding to the resource saving account, etc.

In step 206, the first server receives the account information of resource saving account, binds the electronic exchange account and the resource saving account together; and sends the binding result that result from binding the electronic exchange account and the resource saving account together to the second server.

Since the user has opened a resource savings account, the first server determines that the other servers have already collected the user information and passed the validation to the user information when creating the resource savings account, the user may be determined trusted in this case, triggers the second server to create a virtual credit card account, and send the binding result that results from binding the electronic exchange account and the resource saving account together.

In step 207, the second server receives the binding result that results from binding the electronic exchange account and the resource saving account together, and creates virtual credit card account of the user.

The second server creates virtual credit card accounts for users directly after receiving the binding result that results from binding the electronic exchange account and the resource saving account together, no collection or artificial validation of user information is needed again, It has shortened the process of creating virtual credit card account and has improved the efficiency of creating virtual credit card account, through omitting the process of collecting and artificially validating user information.

The above-described steps 201 and 205 may be separately implemented as the method for creating virtual credit card account on terminal device side, the above-described steps 202, 204 and 206 may be separately implemented as the method for creating the credit card account on the first server side, and the above-described steps 203 and 207 may be separately implemented as the method for creating virtual credit card account on second server side.

In conclusion, the method of creating a credit card account according to examples of the present disclosure, includes: send an indicator indicating no said credit card account exists to the first server when detecting there is no credit card account existing which is corresponding to the real-name user information; The first server sends a binding instruction to the terminal device when detecting that there is no exchange resource account binding to the electronic exchange account, the terminal device acquires and sends an account information of a resource saving account to the first server directed by the binding instruction; the first server receives the account information of resource saving account, binds the electronic exchange account and the resource saving account together, and sends the binding result that results from binding the electronic exchange account and the resource saving account together to the second server.

The second server receives the binding result that results from binding the electronic exchange account and the resource saving account together, and creates virtual credit card account of the user. Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information. It has solved the problems of long time-consuming for applying for a credit card account which results in long process of creating virtual credit card account, and inefficiency of creating virtual credit card account, thereby the efficiency of creating virtual credit card accounts is improved.

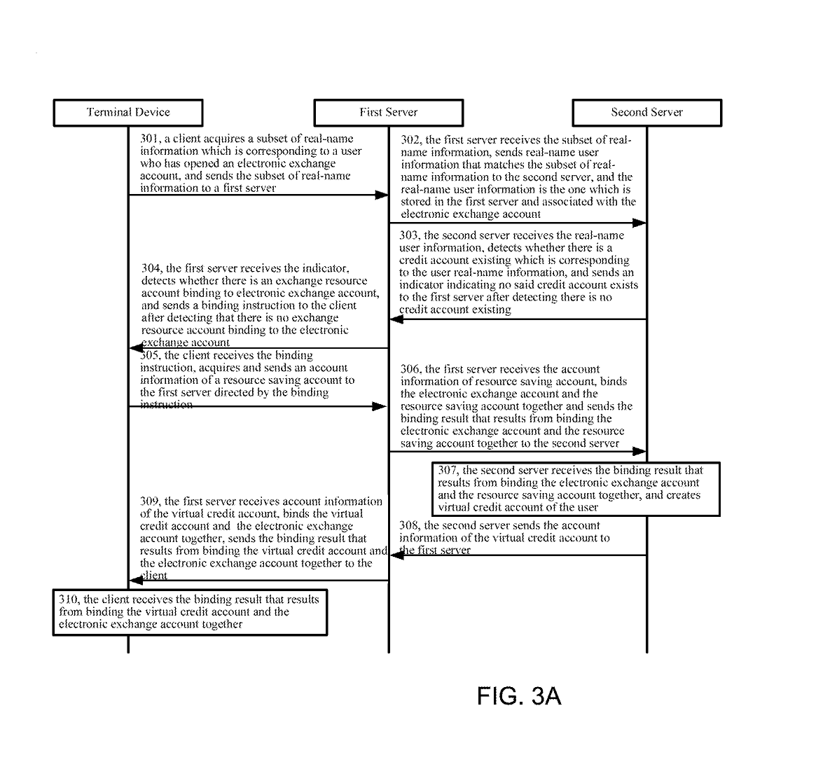

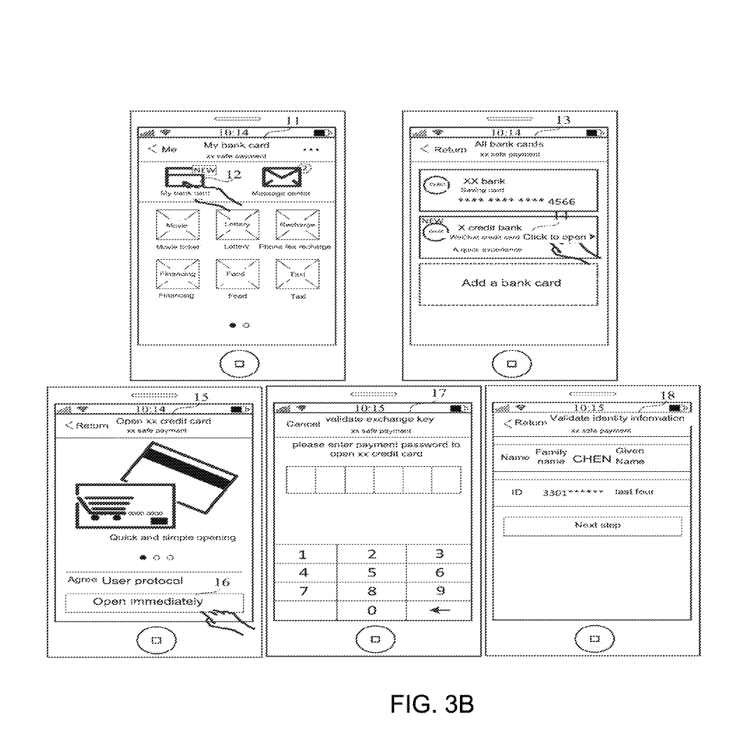

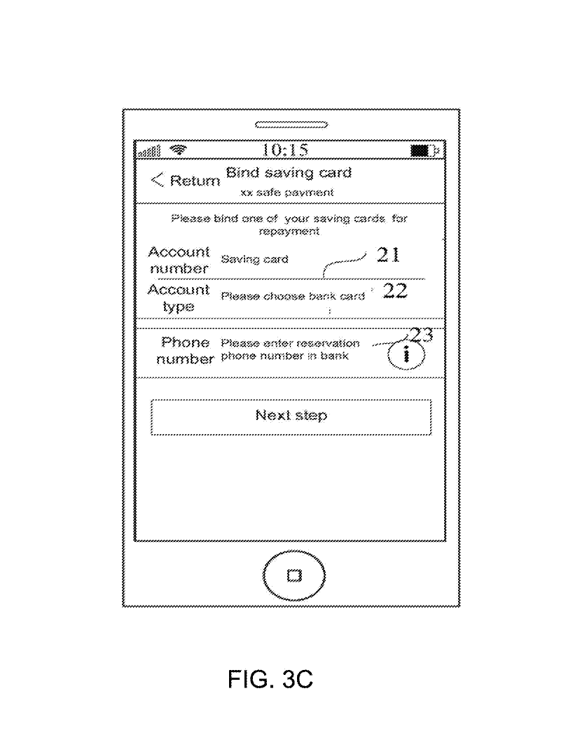

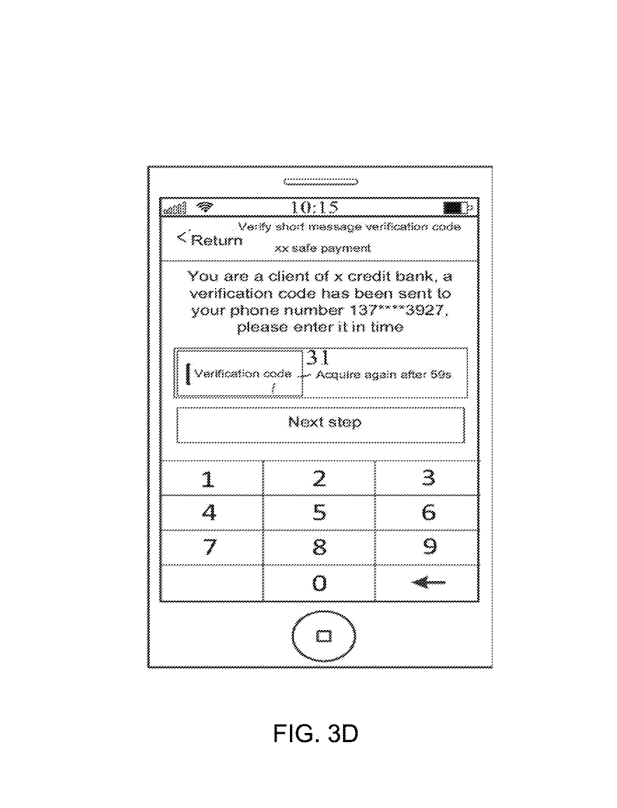

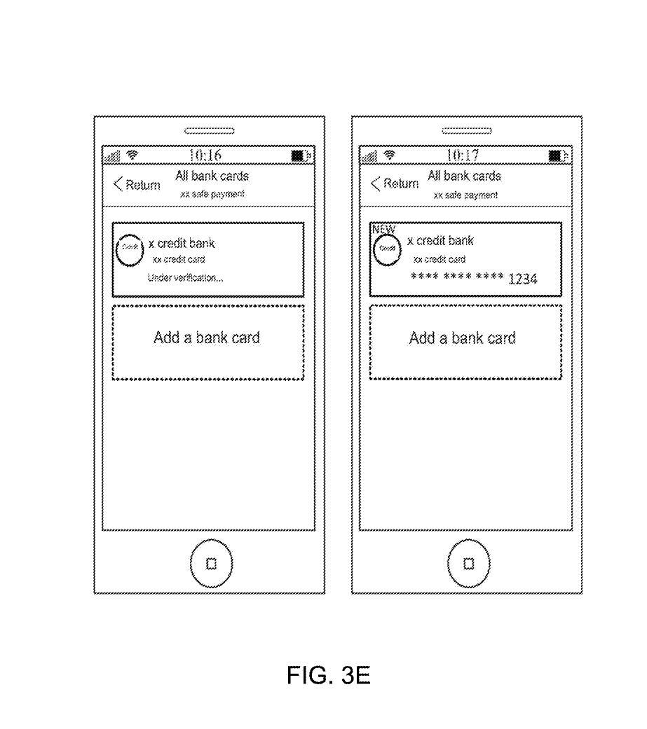

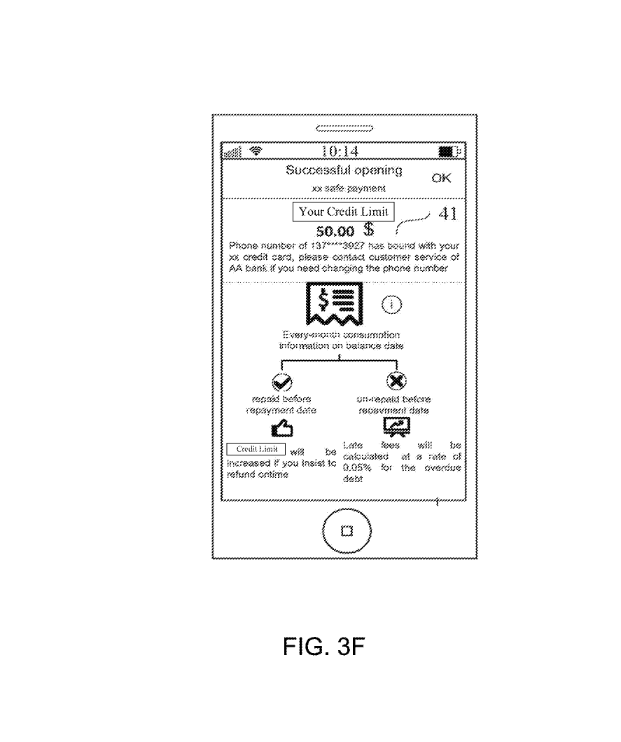

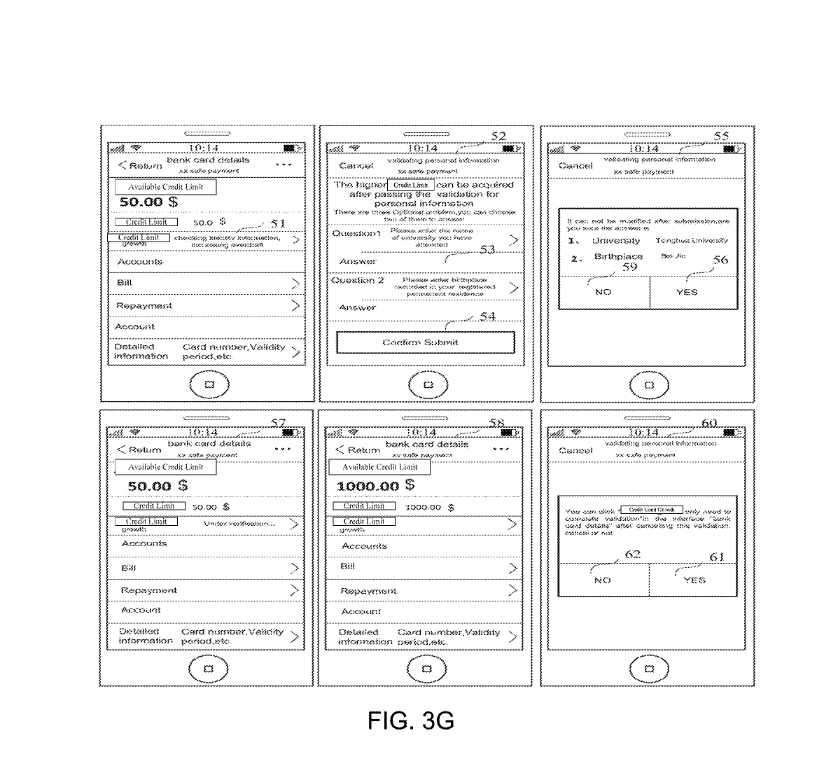

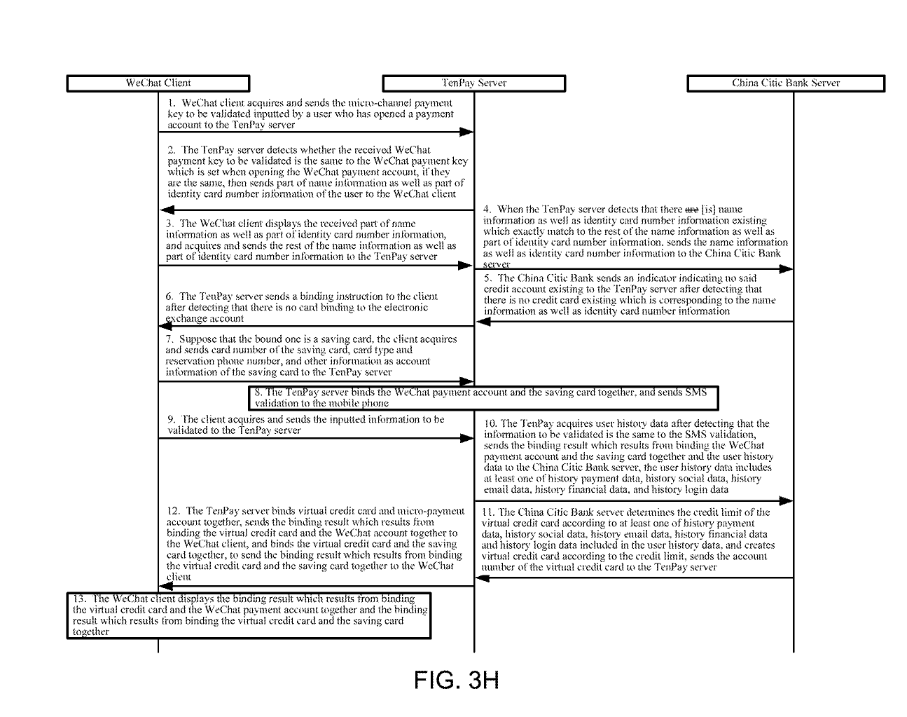

As shown in FIG. 3, it shows a flow chart of the method for creating virtual credit card account according to the other example of present disclosure, the method for creating virtual credit card account, includes following steps.

Step 301, a terminal device acquires a subset of real-name information which is corresponding to a user who has opened an electronic exchange account, and sends subset of real-name information to a first server.

If the user needs to apply for creating a virtual credit card account, the terminal device needs to acquire real-name user information of the user, so that the second server may validate user identity according to the real-name user information provided by the terminal device. However, inputting real-name user information will not only increase the volume of inputted information content to reduce the efficiency of creating virtual credit card account, but also easily result in the leak of information to reduce the security of creating virtual credit card account. Therefore, in the case that the user has opened an electronic exchange account, the terminal device may merely acquire and send the subset of real-name information to the first server, and the first server then sends the pre-stored real-name user information acquired to the second server, so as to increase the security of creating virtual credit card account.

Since the subset of real-name information may be used to match complete user information, the subset of real-name information may be part of the real-name user information, also may be the information corresponding to real-name user information. The present examples are described based on that the subset of real-name information may is part of the real-name user information.

In detail, the subset of real-name information may include at least one class of subset of real-name sub-information, each class of subset of real-name sub-information is part of the real-name sub-information of the corresponding class of real-name user information. For example, the real-name sub-information included in the subset of real-name information are name information and identity card number information respectively, therefore, at least one class of subset of real-name sub-information includes part of name information as well as part of identity card number information, another class of subset of real-name sub-information includes part of identity card number information. Thus, at least one class of subset of real-name sub-information includes part of name information as well as part of identity card number information.

Optionally, in order to ensure that the user himself applies for a virtual credit card account to increase the security of creating virtual credit card account, the terminal device may also validate user identity before acquiring subset of real-name information. The terminal device may acquire the subset of real-name information when validating that it is the user himself applying for the virtual credit card account, and does not respond to this application operations when validating that it is not the user himself applying for the virtual credit card account.

In detail, before acquiring the subset of real-name information of a user who has opened an electronic exchange account, the method further includes: the terminal device acquires an exchange key to be validated, and sends the exchange key to be validated to the first server; and

The first server receives the exchange key to be verified, detects whether the exchange key to be validated is the same as the pre-stored exchange key, when detecting that the exchange key to be validated is the same as the pre-stored exchange key, the first server triggers the terminal device to acquire the subset of real-name information of a user who has opened an electronic exchange account, and the exchange key is the one stored in the first server.

The exchange key may be settled and stored in the first server when the user opens the electronic exchange account. The terminal device may show the inputting interface in which the exchange key to be validated is inputted by the user, determines what the user inputs in the interface as the exchange key to be validated, and sends the exchange key to be validated to the first server, and the first server may detect whether the exchange key to be verified is the same as the exchange key. When detecting that the exchange key to be validated is the same as the pre-stored exchange key, the first server determine that it is the user himself applying for a virtual credit card; when detecting that the exchange key to be validated is not the same as the pre-stored exchange key, the first server determine that it is not the user himself applying for a virtual credit card.

As shown in FIG. 3B, it shows an interface schematic of acquiring the subset of real-name information. If the user needs to apply for creating a virtual credit card, the user first clicks on button 12 “my bank card” in interface 11 “my bank card”, the terminal device will jump to interface 13 “all bank card”; after clicking on “Click immediately open ” button 14 in interface 13 “all bank card” by the user, the terminal device will jump to interface 15 “open xx credit card”; after clicking on button 16 “open” on interface 15 “open xx credit card”, the terminal device will jump to interface 17 “validate exchange key”; If the user inputs the exchange key to be validated in interface 17 “validate exchange key”, the terminal device will jump to interface 18 “validate identity information”. In the present example, assume that subset of real-name information what the user needs to enter includes part of name information as well as part of identity card number information. After inputting the last one of the name and the last four of the identity card number respectively in the corresponding location of the interface 18 “validate identity information”, the terminal device may immediately acquire the user subset of real-name information.

Step 302, the first server receives subset of real-name information, sends real-name user information that matches the subset of real-name information to the second server, and the real-name user information is the one which is stored in the first server and associated with the electronic exchange account.

The first server may find the real-name user information which matches the subset of real-name information in at least one of the pre-stored real-name user information, and sends the real-name user information acquired after matching to the second server. The first server is the server which is communicating to the terminal device, the combination of the both server achieves electronic exchange function.

In detail, sending the real-name user information which matches the subset of real-name information to the second server, includes:

The first server sends the user real-name information to the second server, when at least one class of subset of real-name sub-information is some aspects of the corresponding information of the user real-name information.

The first server may match each piece of real-name user information to the subset of real-name information respectively, and sends the real-name user information which exactly matches to the second server.

Step 303, the second server receives the real-name user information, detects whether there is a credit card account existing which is corresponding to the user real-name information, and sends an indicator indicating no said credit card account exists to the first server after detecting there is no credit card account existing.

Corresponding relationships between the real-name user information of the user who has successfully applied for a credit card account and the different credit card accounts have been stored in the second server, therefore, the second server detects whether the user has successfully applied for a credit card account in the past according to the corresponding relationship.

Since the credit card account of the user does not exist in the second server, therefore, the second server determines the user is incredible, and no virtual credit card account may be created for the user in this case, an indicator indicating no said credit card account exists is sent to the first server.

Step 304, the first server receives the indicator, detects whether there is an exchange resource account binding to electronic exchange account, and sends a binding instruction to the terminal device after detecting that there is no exchange resource account binding to the electronic exchange account.

The first server may determine whether a user is trusted through detecting whether there is an exchange resource account binding to electronic exchange account. The exchange resource account is used to provide exchange resource for the electronic exchange account. The exchange resource account includes resource saving account and the other credit card accounts that are not provided by the second server. The resource saving account may or may not be provided by the second server.

When the exchange resource account is resource saving account, the user may use the exchange resource pre-stored in the resource saving account to exchange goods through electronic exchange accounts; when the exchange resource account is the other credit card account, the user may use the exchange resource withdrawn from the other credit card account to exchange goods through electronic exchange accounts.

The first server sends a binding instruction to the terminal device after detecting that there is no exchange resource account binding to the electronic exchange account, and then triggers the procedure of binding the resource saving account to the electronic exchange account.

Step 305, the terminal device receives the binding instruction, acquires and sends account information of a resource saving account to the first server directed by the binding instruction.

The account information of resource saving account may include account number, account type, the server opening the resource account and the validation terminal identity which is corresponding to the resource saving account and so on.

As shown in FIG. 3C, it shows the interface schematic of acquiring account information, the terminal device instructs the user to enter the card number into the input box 21, the account type into the input box 22, and the phone number into the input box 23 through reminders displayed in the binding interface.

Step 306, the first server receives the account information of resource saving account, binds the electronic exchange account and the resource saving account together and sends the binding result that results from binding the electronic exchange account and the resource saving account together to the second server.

Since the user has opened a resource savings account, the first server may determine that the other servers have already collected the user information and have passed the validation to the user information when creating the resource savings account, the user should be determined to be trusted in this case, the process that the second server creates a virtual credit card account is thereby triggered, and the binding result that results from binding the electronic exchange account and the resource saving account together is sent to the second server.

The first server validates terminal information confirms that the user applying for creating a virtual credit card account at present is the user who has opened resource saving account. Before binding the electronic exchange account and the resource saving account together, and then before binding the electronic exchange account and the resource saving account together, the first server validates terminal information of the user, if the validation is passed, an operation of binding the electronic exchange account and the resource saving account together is triggered.

In the present example, the first server may validate user terminal information via one or any combination of SMS validation, IM validation, voice validation, and email validation. For example, the first server sends one or any of SMS, IM, voice messages, e-mail to the terminal, and validates whether the terminal receives the above-mentioned information.

In detail, validating the user terminal information may include: the first server receives a validation terminal identity acquired and sent by the terminal device; and validate the validation terminal identity.

Each resource saving account is bound with at least one validation terminal identity which is usually the phone number reserved by the user when opening resource saving account. In other possible cases, validation terminal identity may also be e-mail address, IM number, landline phone number, and so on.

The terminal device may first acquire the validation terminal identity binding to the exchange resource account, and then send the acquired validation terminal identity to the first server, confirm that the user applying for creating a virtual credit card account at present is the user who has opened resource saving account, through validating the user identity according to the validation terminal identity by the first server.

In detail, validating validation terminal identity includes: the first server sends validation information to the validation terminal indicated by the validation terminal identity; and receive validation information, detect whether information to be validated is the same to the validation information, if detecting the information to be validated is the same to the validation information, then validation for validation terminal identity is passed.

If the validation terminal identity is the phone number inputted by the user on the terminal device for example, the first server sends validation information to the corresponding phone according to the phone number. In general, validation information is composed of several numbers and or letters.

Meanwhile, the first server may trigger the terminal device to display related validation interface. Referring to FIG. 3D, it shows an interface schematic of a typical validation interface. The terminal device instructs the user to enter the information to be validated into the input box 31 through reminders displayed in the validation interface.

If the phone number inputted by the user when opening resource saving account is the one which is currently used by the user, then the user may view the validation information sent by the first server. Afterward, the user input information to be validated into the validation interface displayed on the terminal device, that is, to input the validation information into the validation interface as the information to be validated. Preferably, when the terminal where the terminal device is running is the validation terminal, the terminal device may directly identify and extract the information to be validated from the SMS received by the validation terminal, and the extracted information to be validated is sent to the first server to be validated.

Step 307, the second server receives the binding result that results from binding the electronic exchange account and the resource saving account together, and creates virtual credit card account of the user; and the second server triggers creating virtual credit card accounts of the user, after receiving the binding result that results from binding the electronic exchange account and the resource saving account together.

In this example, before creating virtual credit card accounts of the user, the method further includes:

(1) the first server acquires user history data according to the electronic exchange account, and sends the user history data to the second server;

(2) The second server receives the user history data which is used to create the virtual credit card account.

Creating the virtual credit card account of the user includes: the second server creates the virtual credit card account of the user according to the user history data.

As shown in FIG. 1 which shows the implement environment, the first server may acquire the user history data from the electronic exchange account, for example, the first server sends historical exchange data and historical login data as the user history data to the second server.

When the terminal device may be used for many purposes, the first server may acquire historical data from other bound or associated electronic account respectively. The historical data in different electronic accounts may be stored either in the same server or different servers. In this example, it is to be described in the case of storing in different servers.

For instance, the terminal device possesses electronic exchange function and social function, and then the electronic exchange function is bound with the electronic social function, the first server may directly read the historical exchange data from the user exchange records in this case; and historical social data from the social server which is corresponding to the historical social account is acquired, and the historical exchange data and historical login data are as the user history data to be sent to the second server.

In detail, creating the user credit card account according to the user history data includes:

(1) the second server accesses at least one of history payment data, history social data, history email data, history financial data, and history login data of the user history data;

(2) the second server determines the credit limit of the virtual credit card account according to at least one of history payment data, history social data, history email data, history financial data and history login data, with the credit limit identifying the max spending amount for the virtual credit card account; and

(3) the second server creates the virtual credit card account according to the credit limit.

The second server determines the credit limit according to historical login data. For example, the more the user logins in the electronic exchange account in history, the greater the credit limit is; for example, the longer the online time is, the greater the credit limit is; Since the history login data reflects the activity in user daily life, the activity may be used as a reference to the user credit. And/or, the second server determines the credit limit according to history exchange data. For example, the more the user exchanges in the electronic exchange account in history the greater the credit limit is; for example, the greater the amount of the history exchange is, the greater the credit limit is; In the present example, it only takes history login data and/or history exchange data for example to illustrate the determining of the credit limit, the first server may determine the credit limit in the same way according to other history data.

When the user history data is with history exchange data, and/or history social data, and/or history email data, and/or history financial data, and/or history login data, the first server may determine an appropriate credit limit by the combination of history exchange data, and/or history social data, and/or history email data, and/or history financial data, and/or history login data. If the user history data also includes basic personal information, the second server may determine a more appropriate credit limit by the combination of history exchange data, and/or history social data, and/or history email data, and/or history financial data, and/or history login data as well as basic personal information at the moment, Since the second server may determine the user credit limit according to the user actual usage, therefore the accuracy of setting the credit limit of the virtual credit card account credit limit is increased.

As shown in FIG. 3E, it shows the interface schematic of virtual credit card account during and after validation. The FIG. on left side is the schematic of virtual credit card account during validation; the FIG. on right side is the schematic of virtual credit card account after validation.

Step 308, the second server sends the account information of the virtual credit card account to the first server.

The second server sends the account information of the virtual credit card account to the first server after creating the virtual credit card account of the user; the account information includes the account number and the credit limit. The account information may also include the date of creating the virtual credit card account, the validity period of the virtual credit card account, the deadline of filling resources, and so on.

Step 309, the first server receives account information of the virtual credit card account, binds the virtual credit card account and the electronic exchange account together, sends the binding result that results from binding the virtual credit card account and the electronic exchange account together; and after binding the both by the first server, the user may select the items desired to exchange after logging in the electronic exchange account, and then make the payments from the virtual credit card account to complete the exchange.

Optionally, after receiving the account information of the virtual credit card account, the method further includes:

(1) when the account type is a resource saving account, the first server binds the virtual credit card account and the resource saving account together, and sends the binding result that results from binding the virtual credit card account and the resource saving account together to the terminal device, with the resource saving account being configured to transfer resource such as fund to inject the virtual credit card account from the resource saving account after the virtual credit card account is over the credit limit; and

(2) the terminal device receives the binding result that results from binding the virtual credit card account and the resource saving account together.

Because it also needs to transfer fund into the virtual credit card account, after the balance of the virtual credit card account exceeds the credit limit, therefore, when the account type is resource saving account, the first server may bind the resource saving account and the virtual credit card account together, in order to transfer resource (fund) to inject the virtual credit card account from the resource saving account after the virtual credit card account is over credit limit. Therefore, it helps to improve the convenience in the process of using the virtual credit card account.

Step 310, the terminal device receives the binding result that results from binding the virtual credit card account and the electronic exchange account together.

The terminal device receives and displays the binding result sent by the first server. The binding results may carry account number of virtual credit card account, the credit limit, the date of creating virtual credit card account, the validity period of the virtual credit card account, the deadline of filling resources, and any other information.

As shown in FIG. 3F, it shows an interface schematic of the binding result, and the terminal device may display the credit limit 41 in order to inform the user after the binding result is received.

It should be added that, when finding the credit limit of the virtual credit card account is not enough during using the virtual credit card account, the user may also apply for increasing the credit limit of the virtual credit card account. After receiving the binding result that results from binding the virtual credit card account and the electronic exchange account together, further includes:

(1) The terminal device acquires and sends user complete information to the first server, the user complete information is used for increasing the credit limit of the virtual credit card account by the second server;

(2) The first serve receives the user complete information, and sends the user complete information to the second server; and

(3) The second server receives the user complete information, and increases the credit limit of the virtual credit card account according to the user complete information.

In detail, the user complete information is mainly used to provide reference for the second server to increase the credit limit of the virtual credit card account. The user complete information may include the user personal information, such as age, date of birth, native place, education, historical schools, home address, contact address, and immediate family members, etc.

The user complete information may be the basic personal information which is inputted randomly by the user on the terminal device, may also be the answer inputted in the interface in the terminal device for the pre-set questions with regard to the first server and/or the second server, and this example has no limited way to acquire the user complete information.

Optionally, you may also set the necessary information what the user complete information has to carry. For example, when the necessary information is the history school of the user attended, the user complete information may not be submitted if the user does not input the history school information. Or, further, when the real-name user information of the first server does not include history school information, the first server or the second server may not validate the history school information inputted by the user in this case, and the interface of the terminal device does not provide the enhance to increase the credit limit.

As shown in FIG. 3G, it shows the interface schematic of entrance to increase credit limit, when the interface of the terminal device provide the entrance to increase credit limit, clicking the button 51 “credit limit growth” (checking identity information, increasing credit limit), the terminal device will jump to interface 52 “validating personal information”; the terminal device instructs the user to input answer into the input box 53 through the reminder displayed in the interface 52 “validating personal information”; after clicking button 54 “Confirm Submit” in the interface 52 “validating personal information” by the user, the terminal device will jump to interface 55 “submitting confirmation”; If the user clicks the button 56 “Yes” in the interface 55 “submitting confirmation”, the terminal device will jump to interface 57 “bank card details”, interface 57 displays the reminder “Validating”.

If the validation to the answer made by the second server has passed, the terminal device will jump to the interface 58 “bank card details”, at the moment the credit limit is increased from 50 to 1000. If the user clicks the button 59 “No” in the interface 55 “Submit confirm”, the terminal device will jump to the interface 60 “validate personal information”; If the user clicks the button 61 “Yes” in the interface 60 “validate personal information”, then the terminal device will return the interface providing the entrance to increase the credit limit; if the user clicks the button 62 “No” in the interface 60 “validate personal information”, the terminal device will returns interface 52 “check personal information”.

In this example, the threshold for the number of cancelling validation may be set, when the number of cancelling validation reaches the threshold, the terminal device no longer provides the entrance to increase the credit limit for the user.

The above steps 301, 302 and 310 may be implemented separately as the method for creating virtual credit card account on terminal device side, the above steps 302, 304,306 and 309 may be implemented separately as the method for creating virtual credit card account on first server side, the above-described steps 303,307 and 308 may be implemented separately as the method for creating virtual credit card account on the second server side.

As shown in FIG. 3H, it shows a flow chart of the method for creating virtual credit card. In this example, it takes that the terminal device is the WeChat client, the electronic exchange account is the Tenpay server, the second server is the China Citic Bank server, the electronic exchange account is the WeChat payment account, the virtual credit card account is the China Citic virtual credit card, the resource saving account is the saving card, the exchange key is the micro-channel payment key for example to describe the procedure of opening a virtual credit card.

1. WeChat client acquires and sends the WeChat payment key to be validated inputted by a user who has opened a payment account to the Tenpay server.

2. The Tenpay server detects whether the received WeChat payment key to be validated is the same to the WeChat payment key which is set when opening the WeChat payment account, if they are the same, then sends part of name information as well as part of identity card number information of the user to the WeChat client.

3. The WeChat client displays the received part of name information as well as part of identity card number information, and acquires and sends the rest of the name information as well as part of identity card number information to the Tenpay server.

4. When the Tenpay server detects that there are name information as well as identity card number information existing which exactly match to the rest of the name information as well as part of identity card number information, sends the name information as well as identity card number information to the China Citic Bank server.

5. The China Citic Bank sends an indicator indicating no said credit card account existing to the Tenpay server after detecting that there is no credit card existing which is corresponding to the name information as well as identity card number information.

6. The Tenpay server sends a binding instruction to the terminal device after detecting that there is no card binding to the electronic exchange account.

7. Suppose that the bound one is a saving card, the terminal device acquires and sends card number of the saving card, card type and reservation phone number, and other information as account information of the saving card to the Tenpay server.

8. The TenPay server binds the WeChat payment account and the saving card together, and sends SMS validation to the mobile phone.

9. The terminal device acquires and sends the inputted information to be validated to the Tenpay server.

10. The TenPay acquires user history data after detecting that the information to be validated is the same to the SMS validation, sends the binding result which results from binding the Wechat payment account and the saving card together and the user history data to the China Citic Bank server, the user history data includes at least one of history payment data, history social data, history email data, history financial data, and history login data.

11. The China Citic Bank server determines the credit limit of the virtual credit card according to at least one of history payment data, history social data, history email data, history financial data and history login data included in the user history data, and creates virtual credit card according to the credit limit, sends the account number of the virtual credit card to the Tenpay server.

12. The TenPay server binds virtual credit card and micro-payment account together, sends the binding result which results from binding the virtual credit card and the WeChat account together to the WeChat client, and binds the virtual credit card and the saving card together, to send the binding result which results from binding the virtual credit card and the saving card together to the WeChat client.

13. The WeChat client displays the binding result which results from binding the virtual credit card and the WeChat payment account together and the binding result which results from binding the virtual credit card and the saving card together.

In conclusion, the method of creating a credit card account according to examples of the present disclosure, includes: send an indicator indicating no said credit card account exists to the first server when detecting there is no credit card account existing which is corresponding to the real-name user information; The first server sends a binding instruction to the terminal device when detecting that there is no exchange resource account binding to the electronic exchange account, the terminal device acquires and sends an account information of a resource saving account to the first server directed by the binding instruction; the first server receives the account information of resource saving account, binds the electronic exchange account and the resource saving account together, and sends the binding result that results from binding the electronic exchange account and the resource saving account together to the second server. The second server receives the binding result that results from binding the electronic exchange account and the resource saving account together, and creates virtual credit card account of the user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed method has solved the problems of long time-consuming for applying for a credit card account which results in long process of creating virtual credit card account, and inefficiency of creating virtual credit card account, thereby the efficiency of creating virtual credit card accounts is improved.

In addition, detect whether there is real-name user information existing which exactly matches to the subset of real-name information, when each of basic information of the subset of real-name information are some aspects of the corresponding information of the user real-name information, and send the real-name user information to the second server after detecting there is real-name user information existing. Since the user merely needs to enter part of the information, it may simplify the input procedure by the user to further increase the efficiency of creating a credit card account.

The present discloses provides a method for creating a virtual credit card to be stored in a data storage. The method may include:

Receiving a subset of real-name information from a user interface by a terminal device, wherein the subset of the real-name information comprises at least a portion of: a user name or a user identification number, wherein the portion is associated with an electronic exchange account stored in the data storage of a first server;

Receiving, by the first server, the subset of the real-name information;

Searching the real-name information stored in the first server with the subset of the real-name information, wherein the real-name information is pre-stored in the data storage of the first server;

Upon the real-name information is found in the first server, sending the real-name information from the first server to the second server, and finding, by the second server, whether the real-name information associates with a credit account stored in the second server;

After finding the credit account is not stored in the second server, sending a credit indicator from the second server to the first server;

Determining, by the first server, whether an exchange resource account tying to the electronic exchange account is stored in the first server after the credit indicator is received by the first server;

If the exchange resource account tying to the electronic exchange account is not stored in the first server, sending, by the first server, a binding instruction to the user interface of the terminal device;

According to the binding instruction, receiving account information of a resource saving account from the user interface of the terminal device, and sending, by the terminal device, the account information to the first server;

Receiving, by the first server, the account information of the resource saving account, and storing the account information in the first server, binding the electronic exchange account and the resource saving account, and sending a binding result that results from binding the electronic exchange account and the resource saving account to the second server;

Receiving, by the second server, the binding result from the first sever, and creating a virtual credit card account; and

Storing the virtual credit card associated with the virtual credit card account in the data storage of the first server.

The virtual credit card may be stored in the first server after the second server creates the virtual card account. The virtual credit card may be tied with the electronic account and/or the exchange resource account. The first server may provide the cardholder means to access the card, such as an additional user interface to access the card via a terminal device. The terminal device may be cardholder's own mobile phone, mobile terminal or another other devices. The access to the virtual credit card may be provided to the cardholder after the verification of the cardholder is passed. Any verification means, either currently known or later developed, may be used for such verification purpose. By this way, the user does not need to have a physical credit card.

In case the virtual credit card tied with the electronic exchange account, the historical data stored or obtained by the first server may be used to verify the cardholder for the virtual credit card. In addition, the cardholder's own phone may provide built-in methods for the verification, such as fingerprint verification.

As such, the first server may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

Before the step of creating the virtual credit card account, the method may include: acquiring user history data stored in the data storage of the first server according to the electronic exchange account, and sending the user history data to the second server; and receiving the user history data by the second server, and creating the virtual credit card account by using the user history data.

When creating the virtual credit account by using the user history data, the method may include: analyzing the user history data by accessing at least one of: user payment data, user social data, historical email data, historical financing data and historical login data that are included in the user history data received by the second server; and determining, by the second server, the credit limit of the virtual credit card account according to the analyzed user history data.

Before binding the electronic exchange account and the resource saving account, the method may include: validating the terminal device by the first server, wherein validating the terminal device comprises:

Receiving, by the first server, a validation terminal identity from the user interface of the terminal device; sending validation information to a second user interface according to the validation terminal identity received by the first server; in response to sending the validation information, receiving second validation information to be validated from the terminal device; determining whether the second validation information matches the validation information; and validating the terminal device by saving an indicator in the data storage of the first server to indicate the terminal device is validated if the second validation information matches the validation information.

When validating the terminal device by the first server, the method may further include: validating the terminal device by using at least one of: SMS validation, instant messaging validation, voice validation, and email validation.

After creating the virtual credit card account, the method may further include: sending, by the second server, virtual credit card account information to the first server; receiving, by the first server, the virtual credit card account information, binding the virtual credit card and the electronic exchange account; and sending, by the first server, a second binding result that results from binding the electronic exchange account and the virtual credit card to be displayed in the user interface of the terminal device.

After sending the second binding result to the user interface, the method may further include: receiving a second set of user information from the user interface of the terminal device; acquiring, by the first server, the second set of the user information and sending the acquired second set of information to the second server; increasing, by the second server, the credit limit for the virtual credit card account stored in the second server; and attaching the increased credit limit to the virtual credit card stored in the first server.

After receiving the virtual credit card account information, the method may further include: binding, by the first server, the virtual credit card and the resource saving account stored in the first server, and displaying a notification in the user interface of the terminal device to notify that the virtual credit and the resource saving account are bound; and automatically transferring, by the first server, fund from the bound resource saving account to the virtual credit card stored in the first server when the virtual credit card is overdrawn.

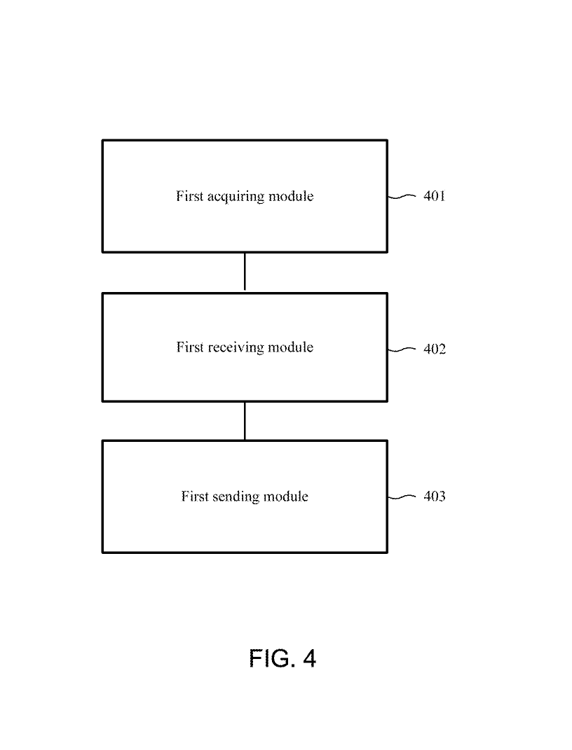

As shown in FIG. 4, it shows a frame diagram of device for creating virtual credit card account according to the example of present disclosure, and the device for creating virtual credit card account may be employed by the terminal device. The device for creating virtual credit card account includes:

A first acquiring module 401, configured to acquire and send a subset of real-name information of a user who has opened an electronic exchange account to the first server, with the subset of real-name information is configured to trigger the first server to send a real-name user information that matches the subset of real-name information to a second server, and the real-name user information being configured to trigger the second server to send an indicator indicating no said credit card account exists to the first server. After detecting there is no credit card account exists to correspond to the real-name user information, the indicator is configured to trigger the first server to send a binding instruction to the terminal device after detecting that there is no exchange resource account binding to said electronic exchange account, and the real-name user information being saved in the first server;

A first receiving module 402, configured to receive the binding instruction from the first server according to the subset of real-name information sent by the first acquiring module 401, and acquire the account information of resource saving account under the binding instruction;

A first sending module 403, configured to send the account information of resource saving account received by the first receiving module 402 to the first server, with the account information of resource saving account triggering first server to bind the electronic exchange account and the resource saving account together, and send the binding result of the electronic exchange account and the resource saving account to the second server, and the binding result that results from binding the electronic exchange account and the resource saving account triggering the second server to create a virtual credit card account of said user.

In conclusion, the method of creating a credit card account according to examples of the present disclosure, includes: sending the subset of real-name information to the first server, with the subset of real-name information being configured to trigger the first server to send a real-name user information that matches the subset of real-name information to a second server, the real-name user information being configured to trigger the second server to send an indicator indicating no said credit card account exists to the first server, after detecting there is no credit card account exists to correspond to the real-name user information, the indicator is configured to trigger the first server to send a binding instruction to the terminal device after detecting that there is no exchange resource account binding to said electronic exchange account, and the real-name user information being saved in the first server; sending the account information of resource saving account to the first server, with the account information of resource saving account triggering first server to bind the electronic exchange account and the resource saving account together, and send the binding result of the electronic exchange account and the resource saving account to the second server, and the binding result that results from binding the electronic exchange account and the resource saving account triggering the second server to create a virtual credit card account of said user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed method has solved the problems of long time-consuming for applying for a credit card account which results in long process of creating virtual credit card account, and inefficiency of creating virtual credit card account, thereby the efficiency of creating virtual credit card accounts is improved.

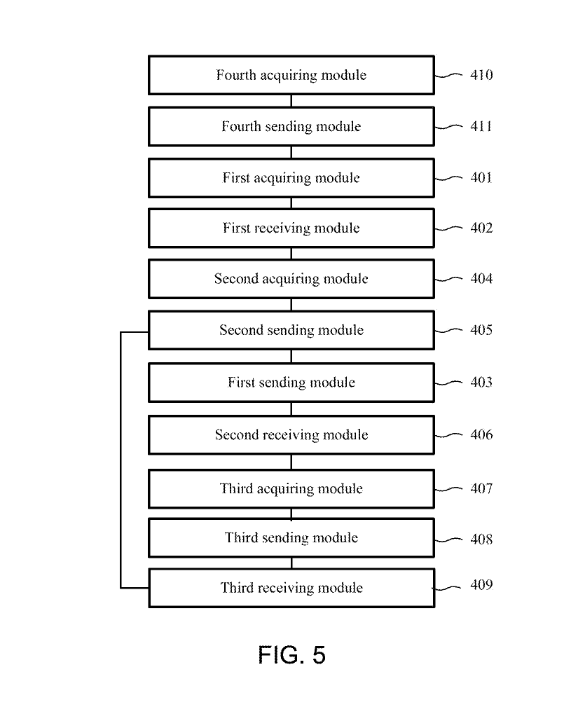

As shown in FIG. 5, it shows a frame diagram of device for creating virtual credit card account according to the other example of present disclosure. The device for creating virtual credit card account may be applied to the terminal device. The device for creating virtual credit card account includes a first acquiring module 401, a first receiving module 402, and a first sending module 403.

The first acquiring module 401 is configured to acquire and send a subset of real-name information of a user who has opened an electronic exchange account to the first server, with the subset of real-name information being configured to trigger the first server to send a real-name user information that matches the subset of real-name information to a second server, and the real-name user information being configured to trigger the second server to send an indicator indicating no said credit card account exists to the first server, after detecting there is no credit card account exists to correspond to the real-name user information, the indicator is configured to trigger the first server to send a binding instruction to the terminal device after detecting that there is no exchange resource account binding to said electronic exchange account, and the real-name user information being saved in the first server;

The first receiving module 402 is configured to receive the binding instruction from the first server according to the subset of real-name information sent by the first acquiring module 401, and acquire the account information of resource saving account under the binding instruction.

The first sending module 403 is configured to send the account information of resource saving account received by the first receiving module 402 to the first server, with the account information of resource saving account triggering first server to bind the electronic exchange account and the resource saving account together, and send the binding result of the electronic exchange account and the resource saving account to the second server, and the binding result that results from binding the electronic exchange account and the resource saving account triggering the second server to create a virtual credit card account of said user.

Optionally, the subset of real-name information includes at least one class of subset of real-name sub-information.

Optionally, at least one class of subset of real-name sub-information includes part of name information as well as part of identity card number information.

Optionally, the device further includes:

A second acquiring module 404, which is configured to acquire a validation terminal identity after the first receiving module 402 receives the binding instruction, and send the validation terminal identity to the first server, allowing the first server to send a validation information to a validation terminal indicated by the validation terminal identity;

A second sending module 405, configured to acquire information to be validated, and send the information to be validated to the first server, allowing the first server to trigger an operation of binding the electronic exchange account and the resource saving account together when the information to be validated is identical with the validation information.

Optionally, the device further includes:

A second receiving module 406, configured to receive the binding result that results from binding the electronic exchange account and the virtual credit card account together sent by the first server after the first sending module 403 sends the account information of the resource saving account to the first server, with the binding result that results from binding the electronic exchange account and the virtual credit card account being the account information of the virtual credit card account, which is sent from the second server to the first server after the electronic exchange account and the virtual credit card account are bound by the first server.

Optionally, the device further includes:

A third acquiring module 407, configured to acquire user complete information, after the second acquiring module 406 receives the binding result that results from binding the electronic exchange account and the virtual credit card account sent by the first server, with the user complete information being used for increasing the credit limit of the virtual credit card account by the second server; and

A third sending module 408, configured to send the user complete information received by the third acquiring module 407 to the first server, allowing the first server to send the user complete information to the second server, with the second server increasing the credit limit of the virtual credit card account referring to the user complete information.

Optionally, the device further includes:

A third receiving module 409, configured to receive the binding result that results from binding the virtual credit card account and the resource saving account to the terminal device, after the first sending module 403 sends the account information of resource saving account to the first server, with the binding result that results from binding the resource saving account and the virtual credit card account being the account information of the virtual credit card account, which is sent from the second server to the first server after the electronic exchange account and the virtual credit card account are bound by the first server, with the resource saving account being configured to transfer resource such as fund to inject the virtual credit card account after the virtual credit card account is over credit limit.

Optionally, the device further includes:

A forth acquiring module 410, configured to acquire exchange key to be validated, before the first acquiring module 401 acquires the subset of real-name information of the user who has opened an electronic exchange account; and

A forth sending module 411, configured to send the exchange key to be validated acquired by the forth acquiring module 410 to the first server, so that the first server triggers the terminal device to acquire the subset of real-name information of a user who has opened an electronic exchange account, when detecting that the exchange key to be verified is the same to the pre-stored exchange key, with the exchange key being related to the electronic exchange account and the one stored in the first server.

In conclusion, the method of creating a credit card account according to examples of the present disclosure, includes: sending the subset of real-name information to the first server, with the subset of real-name information being configured to trigger the first server to send a real-name user information that matches the subset of real-name information to a second server, the real-name user information being configured to trigger the second server to send an indicator indicating no said credit card account exists to the first server, after detecting there is no credit card account exists to correspond to the real-name user information, the indicator is configured to trigger the first server to send a binding instruction to the terminal device after detecting that there is no exchange resource account binding to said electronic exchange account, and the real-name user information being saved in the first server; sending the account information of resource saving account to the first server, with the account information of resource saving account triggering first server to bind the electronic exchange account and the resource saving account together, and send the binding result of the electronic exchange account and the resource saving account to the second server, and the binding result that results from binding the electronic exchange account and the resource saving account triggering the second server to create a virtual credit card account of said user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed method has solved the problems of long time-consuming for applying for a credit card account which results in long process of creating virtual credit card account, and inefficiency of creating virtual credit card account, thereby the efficiency of creating virtual credit card accounts is improved.

Further, sending the information to be validated to the first server so that the first server triggers the second server to create a virtual credit card account when detecting that the information to be validated is the same to the validation information, it may validate the user identity, and increase the security of creating a virtual credit card account.

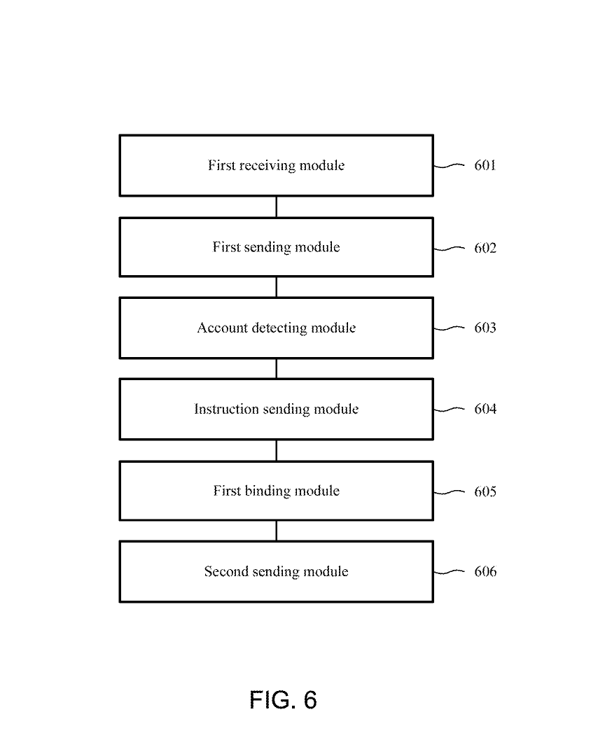

As shown in FIG. 6, it shows a frame diagram of device for creating virtual credit card account according to an example of present disclosure. The device for creating virtual credit card account is employed by the first server, and the device includes:

A first receiving module 601, configured to receive a subset of real-name information sent by a terminal device, with the subset of real-name information acquired by the terminal device being corresponding to a user who has opened an electronic exchange account;

A first sending module 602, configured to send a real-name user information that matches the subset of real-name information which is received by the first receiving module 601 to a second server, with the real-name user information being configured to trigger the second server send an indicator indicating no said credit card account exists to the first server, after detecting there is no credit card account exists to correspond to the real-name user information, and the real-name user information being saved in the first server;

An account detecting module 603, configured to receive said indicator, and detect whether there is an exchange resource account binding to said electronic exchange account;

An instruction sending module 604, configured to send a binding instruction to the terminal device after detecting that there is no exchange resource account binding to the electronic exchange account by the account detecting module 603, allowing the terminal device to acquire and send an account information of a resource saving account to the first server directed by the binding instruction;

A first binding module 605, configured to receive the account information of resource saving account sent by the instruction sending module 604, and bind the electronic exchange account and the resource saving account together; and

A second sending module 606, configured to send the binding result that results from binding the electronic exchange account and the resource saving account together by the first binding module 605 to the second server, with said binding result triggering the second server to create a virtual credit card account of said user.

In conclusion, the device for creating a credit card account according to the example of the present disclosure, includes: sending a real-name user information that matches the subset of real-name information to a second server, with the real-name user information being configured to trigger the second server send an indicator indicating no said credit card account exists to the first server, after detecting there is no credit card account exists to correspond to the real-name user information, and the real-name user information being saved in the first server; receiving an indicator, and sending a binding instruction to the terminal device after detecting that there is no exchange resource account binding to the electronic exchange account, allowing the terminal device to acquire and send an account information of a resource saving account to the first server directed by the binding instruction; receiving the account information of resource saving account, and bind the electronic exchange account and the resource saving account together; sending the binding result that results from binding the electronic exchange account and the resource saving account together to the second server, with the binding result triggering the second server to create a virtual credit card account of said user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed device has solved the problems of long time-consuming for applying for a credit card account which results in long process of creating virtual credit card account, and inefficiency of creating virtual credit card account, thereby the efficiency of creating virtual credit card accounts is improved.

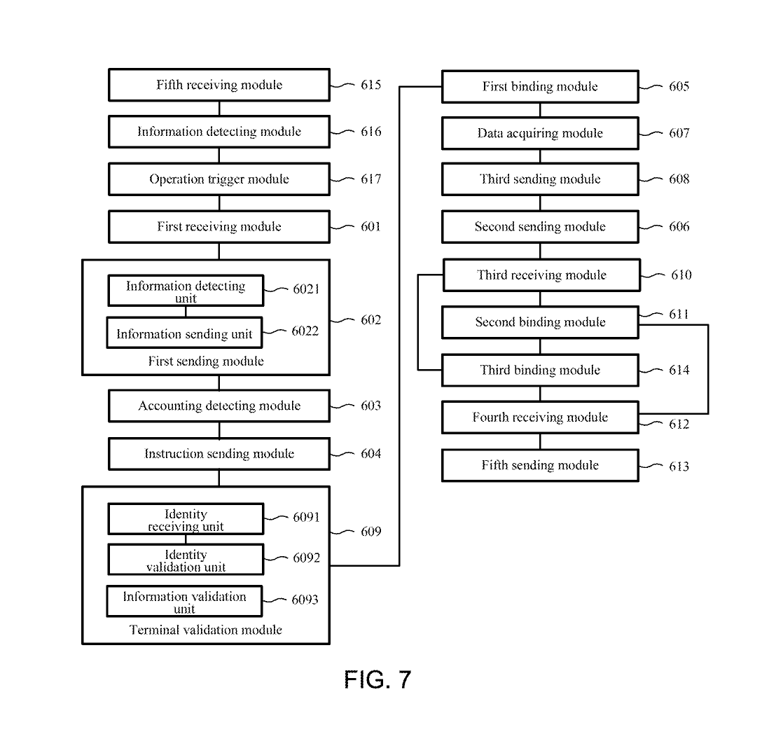

As shown in FIG. 7, it shows a frame diagram of device for creating virtual credit card account according to the example of present disclosure, and the device for creating virtual credit card account is employed by the first server. The device for creating virtual credit card account includes: a first receiving module 601, a first sending module 602, an account detecting module 603, an instruction sending module 604, a first binding module 605, and a second sending module 606.

The first receiving module 601 is configured to receive a subset of real-name information sent by a terminal device, with the subset of real-name information acquired by the terminal device being corresponding to a user who has opened an electronic exchange account.

The first sending module 602 is configured to send a real-name user information that matches the subset of real-name information which is received by the first receiving module 601 to a second server, with the real-name user information being configured to trigger the second server send an indicator indicating no said credit card account exists to the first server, after detecting there is no credit card account exists to correspond to the real-name user information, and the real-name user information being saved in the first server.

The account detecting module 603 is configured to receive said indicator, and detect whether there is an exchange resource account binding to said electronic exchange account.

The instruction sending module 604 is configured to send a binding instruction to the terminal device after detecting that there is no exchange resource account binding to said electronic exchange account by the account detecting module 603, allowing the terminal device to acquire and send an account information of a resource saving account to the first server directed by the binding instruction.

The first binding module 605 is configured to receive the account information of resource saving account sent by the instruction sending module 604, and bind the electronic exchange account and the resource saving account together.

The second sending module 606 is configured to send the binding result that result from binding the electronic exchange account and the resource saving account together by the first binding module 605 to the second server, with said binding result triggering the second server to create a virtual credit card account of said user.

Optionally, the device further includes:

A data acquiring module 607, which is configured to acquire user history data according to the electronic exchange account; and

A third sending module 608, which is configured to send the user history data acquired by the data acquiring module 607, with the user history data being configured to create the virtual credit card account.

Optionally, the subset of real-name information includes at least one class of subset of real-name sub-information.

Optionally, at least one class of subset of real-name sub-information includes part of name information as well as part of identity card number information.

Optionally, the first sending module 602, is further configured to send the user real-name information to the second server, when each subset of real-name sub-information of at least one class of subset of real-name sub-information is some aspects of the corresponding information of the user real-name information.

Optionally, the device further includes:

A terminal validation module 609, configured to validate user terminal information before binding the electronic exchange account and the resource saving account together by the first binding module 605, if the validation is passed, a operation of binding the electronic exchange account and the resource saving account together is triggered thereby.

Optionally, the terminal validation module 609 further includes:

An identity acquiring unit 6091, which is configured to receive a validation terminal identity acquired and sent by the terminal device; and

An identity validation module 6092, which is configured to validate the validation terminal identity acquired by the identity acquiring unit.

Optionally, the identity validation module 6092 is further configured to send the validation information to the validation terminal indicated by the validation terminal identity; receive information to be validated; detect whether the information to be validated is identical with the validation information; if yes, the validation for the validation terminal identity is passed.

Optionally, terminal validation module 609 further includes:

An information validation unit 6093, configured to validate terminal information of the user via one or any combination of SMS validation, IM validation, voice validation, and email validation.

Optionally, the device further includes:

A third receiving module 610, which is configured to receive account information of the virtual credit card account sent by the second receiving module 606, after the second sending module sends the binding result that results from binding the electronic exchange account and the resource saving account together to the second server;

A second binding module 611, which is configured to bind the virtual credit card account and the electronic exchange account together received by the third receiving module 610, and send the binding result that results from binding the electronic exchange account and the virtual credit card account to the terminal device, allowing the terminal device to receive the binding result that results from binding the electronic exchange account and the virtual credit card account.

Optionally, the device further includes:

A fourth receiving module 612, which is configured to receive user complete information acquired and sent by the terminal device, after the second binding module 611 sends the binding result that results from binding the electronic exchange account and the virtual credit card account to the terminal device, with the user complete information being used for increasing the credit limit of the virtual credit card account by the second server; and

A fifth sending module 613, which is configured to send the user complete information received by the fourth receiving module 612 to the second server, allowing the second server to increase the credit limit of the virtual credit card account referring to the user complete information.

Optionally, the device further includes:

A third binding module 614, which is configured to bind the virtual credit card account and the resource saving account after the third receiving module 612 receives the account information of the virtual credit card account, and send the binding result that results from binding the virtual credit card account and the resource saving account to the terminal device, allowing the terminal device to receive the account binding result that results from binding the virtual credit card account and the resource saving account, with the resource saving account being configured to transfer resource to inject the virtual credit card account after the virtual credit card account is over credit limit.

Optionally, the device further includes:

A fifth receiving module 615, configured to receive exchange key to be validated sent by the terminal device, before the first receiving module 601 receives the subset of real-name information sent by the terminal device.

An information detecting module 616, configured to detect that the exchange key to be verified which is received by fifth receiving module 615 is the same to the pre-stored exchange key, with the exchange key being the one stored in the first server and associated with the electronic exchange account; and

An operation trigger module 617, configured to trigger the operation to receive the subset of real-name information sent by the terminal device when the information detecting module 616 detect that the exchange key to be verified is the same to the pre-stored exchange key.

In conclusion, the device for creating a credit card account according to the example of the present disclosure, includes: sending a real-name user information that matches the subset of real-name information to a second server, with the real-name user information being configured to trigger the second server send an indicator indicating no said credit card account exists to the first server, after detecting there is no credit card account exists to correspond to the real-name user information, and the real-name user information being saved in the first server; receiving an indicator, and sending a binding instruction to the terminal device after detecting that there is no exchange resource account binding to the electronic exchange account, allowing the terminal device to acquire and send an account information of a resource saving account to the first server directed by the binding instruction; receiving the account information of resource saving account, and bind the electronic exchange account and the resource saving account together; sending the binding result that results from binding the electronic exchange account and the resource saving account together to the second server, with the binding result triggering the second server to create a virtual credit card account of said user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed device has solved the problems of long time-consuming for applying for a credit card account which results in long process of creating virtual credit card account, and inefficiency of creating virtual credit card account, thereby the efficiency of creating virtual credit card accounts is improved.

In addition, detecting whether there is real-name user information existing which exactly matches to the subset of real-name information when each of basic information of the subset of real-name information are some aspects of the corresponding information of the user real-name information, and sending the real-name user information to the second server after detecting there is real-name user information existing. Since the user only needs to enter part of the information, it may simplify the input procedure by the user, and the efficiency of creating a credit card account is increased.

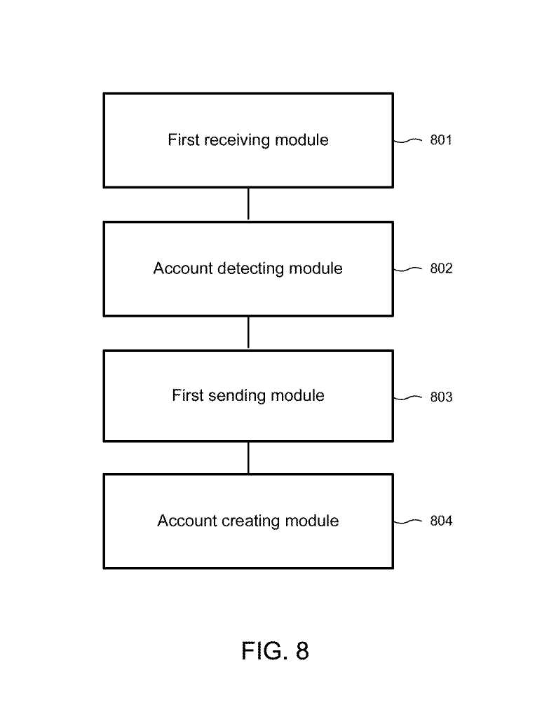

As shown in FIG. 8, it shows a frame diagram of the device for creating virtual credit card account according to the example of present disclosure. The device for creating virtual credit card account is employed by the second server. The device for creating virtual credit card account include:

A first receiving module 801, configured to receive user real-name information which matches the subset of real-name information sent by the first server, with the subset of real-name information which is corresponding to a user who has opened an electronic exchange account being acquired by the terminal device and sent to the first server, and the real-name user information being saved in the first server;

An account detecting module 802, configured to detect whether there is a credit card account exists which is corresponding to the user real-name information received by the first receiving module;

A first sending module 803, configured to send an indicator indicating no said credit card account exists to the first server, after detecting there is no credit card account exists by account detecting module 802, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server; and

An account creating module 804, configured to receive the binding result generated by binding the electronic exchange account and the resource saving account, to create a virtual credit card account of the user.

In conclusion, the device of creating a credit card account according to examples of the present disclosure includes: receiving user real-name information which matches the subset of real-name information sent by the first server, with the subset of real-name information which is corresponding to a user who has opened an electronic exchange account being acquired by the terminal device and sent to the first server, and the real-name user information being saved in the first server; sending an indicator indicating no said credit card account exists to the first server, after detecting there is no credit card account existing, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server; receiving the binding result generated by binding the electronic exchange account and the resource saving account, to create a virtual credit card account of the user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed device has solved the problems of long time-consuming for applying for a credit card account which results in long process of creating virtual credit card account, and inefficiency of creating virtual credit card account, thereby the efficiency of creating virtual credit card accounts is improved.

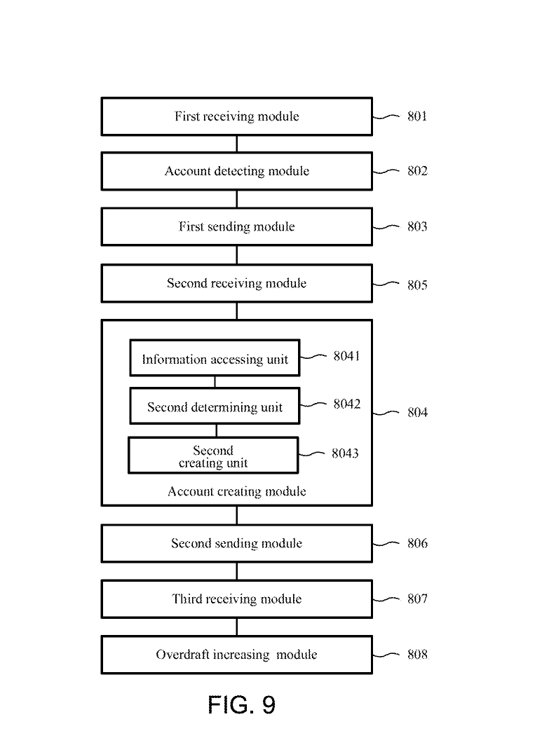

As shown in FIG. 9, it shows a structural diagram of device for creating virtual credit card account according to another example of present disclosure, the device for creating virtual credit card account may be employed by the second server. The device for creating virtual credit card account includes: a first receiving module 801, an account detecting module 802, a first sending module 803 and an account creating module 804.

The first receiving module 801 is configured to receive user real-name information which matches the subset of real-name information sent by the first server, with the subset of real-name information which is corresponding to a user who has opened an electronic exchange account being acquired by the terminal device and sent to the first server, and the real-name user information being saved in the first server.

The account detecting module 802 is configured to detect whether there is a credit card account exists which is corresponding to the user real-name information received by the first receiving module.

The first sending module 803 is configured send an indicator indicating no said credit card account exists to the first server, after detecting there is no credit card account exists by account detecting module 802, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server.

The account creating module 804 is configured to receive the binding result generated by binding the electronic exchange account and the resource saving account, to create a virtual credit card account of the user.

Optionally, the device further includes:

A second receiving module 805, configured to receive user history data sent by the first server, before the account creating module 804 creates the virtual credit card account of the user, with the user history data being acquired by the first server according to the electronic exchange account, and the user history data being configured to create the virtual credit card account.

Optionally, the account creating module 804 creates the virtual credit card account of the user according to the user history data.

Optionally, the account creating module 804, includes:

An information accessing unit 8041, configured to access at least one of history payment data, history social data, history email data, history financing data, and history login data of the user history data;

A credit limit determining unit 8042, configured to determine the credit limit of the virtual credit card account according to at least one of user payment data, user social data, history email data, history financing data and history login data accessed by the information accessing unit 8041, with the credit limit identifying the max spending amount for the virtual credit card account; and

An account creating unit 8043, configured to create the virtual credit card account according to the credit limit determined by the credit limit determining unit 8042.

Optionally, the device further includes:

A second sending module 806, configured to send the account information of the virtual credit card account to the first server after the account creating module create 804 the virtual credit card account of the user, allowing the first server to receive the account information of the virtual credit card account, bind the virtual credit card account and the electronic exchange account together, and send the binding result that results from binding the virtual credit card account and the electronic exchange account to the terminal device, with the terminal device receiving the binding result that results from binding the virtual credit card account and the electronic exchange account.

Optionally, the device further includes:

A third receiving module 807, configured to receive the user complete information forwards by the first server from the terminal device, after the second sending module 806 sends the account information of the virtual credit card account to the first server, with the user complete information being used for increasing the credit limit of the virtual credit card account by the second server; and

A credit limit increasing module 808, configured to increase the credit limit of the virtual credit card account received by the third receiving module 807 referring to the user complete information.

In conclusion, the device of creating a credit card account according to examples of the present disclosure includes: receiving user real-name information which matches the subset of real-name information sent by the first server, with the subset of real-name information which is corresponding to a user who has opened an electronic exchange account being acquired by the terminal device and sent to the first server, and the real-name user information being saved in the first server; sending an indicator indicating no said credit card account exists to the first server, after detecting there is no credit card account existing, with the indicator being configured to trigger the first server to send a binding instruction to the terminal device after detecting that there is no exchange resource account binding to said electronic exchange account, allowing the terminal device to acquire and send an account information of the resource saving account to the first server, and the first server receiving the account information of the resource saving account, and binding the electronic exchange account and the resource saving account to generate a binding result which is sent to the second server; receiving the binding result generated by binding the electronic exchange account and the resource saving account, to create a virtual credit card account of the user.

Combining the existing electronic exchange resource with the resource saving account bound onsite in the process of creating virtual credit card account, and the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed device has solved the problems of long time-consuming for applying for a credit card account which results in long process of creating virtual credit card account, and inefficiency of creating virtual credit card account, thereby the efficiency of creating virtual credit card accounts is improved.

In addition, the credit limit of the virtual credit card account is determined according to historical exchange information and/or historical social information and account type, and the virtual credit card account is created according to the credit limit, the credit limit of the user may be determined according to actual usage of the user, so the accuracy of setting the credit limit of the virtual credit card account is increased.

The present disclosure provides a device for creating a virtual credit card comprising: a first server having a data storage containing real-name information associated with an electronic exchange account; wherein the first server may be configured configured to:

Receive a subset of real-name information from a user interface of a terminal device wherein the subset of the real-name information includes at least a portion of a user name or user identification number, wherein the portion is associated with the electronic exchange account;

Search for the real-name information stored in the data storage using the received subset of the real-name information;

Send the real-name information found in the data storage to the second server for use in finding an associated credit card account stored in the second server;

Receive a credit indicator from the second server if the credit card account is not stored in the second server;

Determine, upon receipt of the credit indicator, whether an exchange resource account associated with the electronic exchange account is stored in the data storage;

Send, upon receipt of a determination that the exchange resource account is not stored in the data storage, a binding instruction to the user interface of the terminal device;

Receive, according to the binding instruction, account information of a resource saving account from the user interface of the terminal device;

Store the account information to the data storage;

Bind the electronic exchange account and the resource saving account;

Send a binding result to the second server;

Receive information associated with a virtual credit card account created by the second sever after receiving the binding result; and

Store the virtual credit card associated with the virtual credit card account in the data storage of the first server.

The first server of the device may store the virtual credit card after the second server creates the virtual card account. The virtual credit card may be tied with the electronic account and/or the exchange resource account stored in the data storage of the first server. The first server may provide the cardholder means to access the card, such as an additional user interface to access the card via a terminal device. The access to the virtual credit card may be provided to the cardholder after the verification of the cardholder is passed. Any verification means, either currently known or later developed, may be used for such verification purpose. By this way, the user does not need to have a physical credit card.

In case the virtual credit card tied with the electronic exchange account, the first server may store or obtain the historical data and used the historical data to verify the cardholder for the virtual credit card. In addition, the first server may detect the verification is passed when the cardholder's own phone provides built-in methods for the verification, such as fingerprint verification.

As such, the first server of the device may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

The first server of the device may be configured to acquire user history data according to the electronic exchange account, and send the user history data to the second server wherein the user history data is used to create the virtual credit card account.

The first server of the device may be configured to validate the terminal device before binding the electronic exchange account and the resource saving account, wherein the first server is further configured to: receive a validation terminal identity from the user interface of the terminal device; send validation information to a second user interface according to the validation terminal identity received by the first server; in response to send the validation information, receive second validation information to be validated from the terminal device; determine whether the second validation information matches the validation information; and validate the terminal device by saving an indicator in the data storage to indicate the terminal device is validated if the second validation information matches the validation information.

The first server of the device may be configured to validate the terminal device by using at least one of: SMS validation, instant messaging validation, voice validation, and email validation.

The first server of the device is configured to receive the virtual credit card account information from the second server, bind the virtual credit card and the electronic exchange account; and send a second binding result that results from binding the electronic exchange account and the virtual credit card to be displayed in the user interface of the terminal device.

The first server of the device may be configured to receive a second set of user information from the user interface of the terminal device; send the received second set of information to the second server, wherein the second set of information is used for increasing the credit limit for the virtual credit card account stored in the second server; and attach the increased credit limit to the virtual credit card stored in the first server.

The first server of the device may be configured to bind the virtual credit card and the resource saving account stored in the data storage, and display a notification in the user interface of the terminal device to notify that the virtual credit and the resource saving account are bound; and automatically transfer fund from the bound resource saving account to the virtual credit card stored in the first server when the virtual credit card is overdrawn.

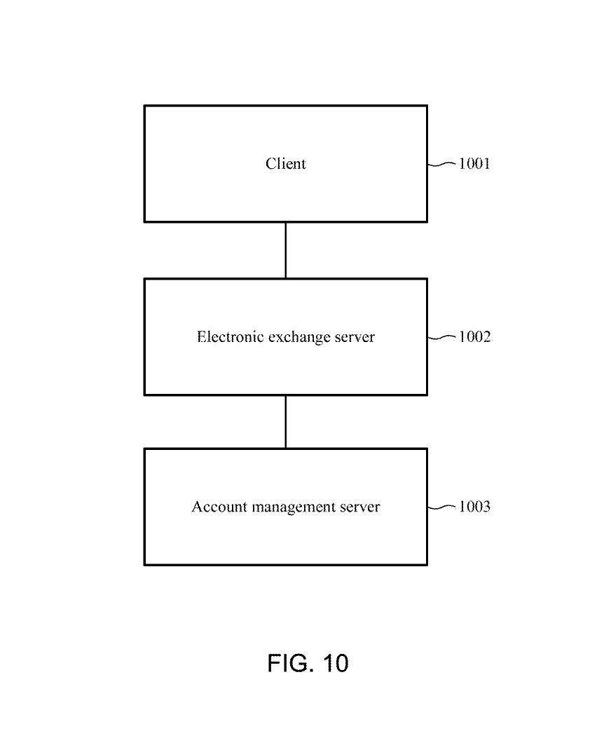

As shown in FIG. 10, it shows a frame diagram of a system for creating virtual credit card account according to the example of present disclosure, and the system for creating virtual credit card account includes:

A terminal device 1001, configured to acquire and send the subset of real-name information of the user who has opened the electronic exchange account to the first server 1002;

A first server 1002, which is configured to receive subset of real-name information, and send real-name user information which matches to the subset of real-name information to the second server 1003, with the real-name user information being stored in the first server 1002;

A second server 1003, configured to receive real-name user information, and detect whether there is a credit card account which is corresponding to the real-name user information existing, and send an indicator indicating no said credit card account exists to the first server 1002, after detecting there is no credit card account exists;

The first server 1002, further configured to receive indicator, detect whether there is an exchange resource account binding to the electronic exchange account, and send a binding instruction to the terminal device after detecting that there is no exchange resource account binding to the electronic exchange account.

A terminal device 1001, configured to receive binding instruction, acquire and send account information of the resource saving account to the first server directed by the binding instruction, and send the account information of the resource saving account to the first server 1002;

The first server 1002, further configured to receive the account information of the resource saving account, and bind the electronic exchange account and the resource saving account to generate a binding result which is sent to the second server 1003; and

The second server 1003, further configured to receive the binding result generated by binding the electronic exchange account and the resource saving account, to create a virtual credit card account of the user.

In conclusion, the method of creating a credit card account according to examples of the present disclosure, includes: send an indicator indicating no said credit card account exists to the first server when detecting there is no credit card account existing which is corresponding to the real-name user information; The first server sends a binding instruction to the terminal device when detecting that there is no exchange resource account binding to the electronic exchange account, the terminal device acquires and sends an account information of a resource saving account to the first server directed by the binding instruction; the first server receives the account information of resource saving account, binds the electronic exchange account and the resource saving account together, and sends the binding result that results from binding the electronic exchange account and the resource saving account together to the second server. The second server receives the binding result that results from binding the electronic exchange account and the resource saving account together, and creates virtual credit card account of the user.

Combining the existing electronic exchange resource with the resource saving account bound onsite in the process of creating virtual credit card account, the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed system has solved the problems of long time-consuming for applying for a credit card account which results in long process of creating virtual credit card account, and inefficiency of creating virtual credit card account, thereby the efficiency of creating virtual credit card accounts is improved.

A system for creating virtual credit card account according to an example of present disclosure, which includes: a terminal device 1001, a first server 1002, and a second server 1003.

The terminal device 1001 is configured to acquire and send the subset of real-name information of the user who has opened the electronic exchange account to the first server 1002.

The first server 1002 is configured to receive subset of real-name information, and send real-name user information which matches to the subset of real-name information to the second server 1003, with the real-name user information being stored in the first server 1002.

The second server 1003 is configured to receive real-name user information, and detect whether there is a credit card account which is corresponding to the real-name user information existing, send an indicator indicating no said credit card account exists to the first server 1002, after detecting there is no credit card account exists.

The first server 1002 is configured to receive indicator, detect whether there is an exchange resource account binding to the electronic exchange account, and send a binding instruction to the terminal device after detecting that there is no exchange resource account binding to the electronic exchange account.

The terminal device 1001 is configured to receive binding instruction, acquire and send an account information of the resource saving account to the first server directed by the binding instruction, and send the account information of the resource saving account to the first server 1002.

The first server 1002 is configured to receive the account information of the resource saving account, and bind the electronic exchange account and the resource saving account to generate a binding result which is sent to the second server 1003.

The second server 1003 is configured to receive the binding result generated by binding the electronic exchange account and the resource saving account, to create a virtual credit card account of the user.

Optionally, the first server 1002 is further configured to acquire user history data according to electronic exchange account before the second server 1003 creates the virtual credit card account of the user, and sends the user history data to the second server 1003, with the user history data being used to create the virtual credit card account of the user.

Optionally, the second server 1003 is further configured to create a virtual credit card account of the user according to user history data.

Optionally, the second server 1003 is further configured to access at least one of the user history data which includes history payment data, history social data, history email data, history financial data, and history login data; determine the credit limit of the virtual credit card account according to at least one of history payment data, history social data, history email data, history financial data and history login data, with the credit limit identifying the max spending amount for the virtual credit card account; the virtual credit card account is created according to the credit limit.

Optionally, the subset of real-name information includes at least one class of subset of real-name sub-information.

Optionally, at least one class of subset of real-name sub-information includes part of name information as well as part of identity card number information.

Optionally, the first server 1002 is further configured to send the user real-name information to the second server 1003, when each subset of real-name sub-information of said at least one class of subset of real-name sub-information is some aspects of the corresponding information of the user real-name information.

Optionally, the first server 1002 is further configured to validate user terminal information before binding the electronic exchange account and the resource saving account together, if the validation is passed, a operation of binding the electronic exchange account and the resource saving account together is triggered.

Optionally, the first server 1002 is further configured to receive a validation terminal identity acquired and sent by the terminal device, and validate the validation terminal identity.

Optionally, the first server is further configured to send a validation information to the validation terminal indicated by the validation terminal identity; receive information to be validated; detect whether the information to be validated is identical with the validation information; and if the information to be validated is identical with the validation information, passing the validation for the validation terminal identity.

Optionally, the first server 1002 is further configured to validate user terminal information via one or any combination of SMS validation, instant messaging validation, voice validation, and email validation.

Optionally, the second server 1003 is further configured to send the account information of the virtual credit card account to the first server 1002 after the account creating module creates the virtual credit card account of the user.

The first server 1002 is further configured to receive the account information of the virtual credit card account, bind the virtual credit card account and the electronic exchange account together, and send the binding result that result from binding the electronic exchange account and the virtual credit card account to the terminal device 1001.

The terminal device 1001 is further configured to receive the binding result that results from binding the electronic exchange account and the virtual credit card account.

Optionally, the terminal device 1001 is further configured to acquire and send user complete information to the first server 1002 after receiving the binding result that results from binding the electronic exchange account and the virtual credit card account, with the user complete information being used for increasing the credit limit of the virtual credit card account by the second server.

The first server 1002 is further configured to receive the user complete information, and send the user complete information to the second server 1003.

The second server 1003 is further configured to receive the user complete information, and increase the credit limit of the virtual credit card account referring to the user complete information.

Optionally, the first server 1002 is further configured to bind the virtual credit card account and the resource saving account together after receiving the account information of the virtual credit card account, send the binding result that results from binding the virtual credit card account and the resource saving account to the terminal device 1001, with the resource saving account being configured to transfer resource to inject the virtual credit card account after the balance of the virtual credit card account exceeds the credit limit; And the terminal device 1001 receives the account binding result that results from binding the virtual credit card account and the resource saving account.

The terminal device 1001 is further configured to receive the binding result that results from binding the electronic exchange account and the virtual credit card account.

Optionally, the terminal device 100 is further configured to acquire and send exchange key to be validated to the first server 1002 before acquiring the subset of real-name information of a user who has opened an electronic exchange account.

The first server 1002 is further configured to receive the exchange key to be validated, detect whether the exchange key to be verified is the same to the pre-stored exchange key, when detecting that the exchange key to be validated is the same to the pre-stored exchange key, the first server triggers the terminal device 1001 to acquire the subset of real-name information of a user who has opened an electronic exchange account, the exchange key is the one stored in the first server 1002.

In conclusion, the method of creating a credit card account according to examples of the present disclosure, includes: send an indicator indicating no said credit card account exists to the first server when detecting there is no credit card account existing which is corresponding to the real-name user information; The first server sends a binding instruction to the terminal device when detecting that there is no exchange resource account binding to the electronic exchange account, the terminal device acquires and sends an account information of a resource saving account to the first server directed by the binding instruction; the first server receives the account information of resource saving account, binds the electronic exchange account and the resource saving account together, and sends the binding result that results from binding the electronic exchange account and the resource saving account together to the second server. The second server receives the binding result that results from binding the electronic exchange account and the resource saving account together, and creates virtual credit card account of the user.

Combining the existing electronic exchange resource with the resource saving account bound onsite in the process of creating virtual credit card account, the second server may acquire user's real-name user information according to the electronic exchange account. After determining the binding result that results from binding the electronic exchange account and the resource saving account together according to the received detecting result, the second server may create virtual credit card accounts for users directly, omitting the process of collecting and artificially validating user information.

The disclosed system has solved the problems of long time-consuming for applying for a credit card account which results in long process of creating virtual credit card account, and inefficiency of creating virtual credit card account, thereby the efficiency of creating virtual credit card accounts is improved.

In addition, detecting whether there is real-name user information existing which exactly matches to the subset of real-name information when each of basic information of the subset of real-name information are some aspects of the corresponding information of the user real-name information, and sending the real-name user information to the second server after detecting there is real-name user information existing. Since the user only needs to enter part of the information, it may simplify the input procedure by the user, and the efficiency of creating a credit card account is increased.

The present disclosure provides a system for creating virtual credit to be stored in a data storage. The system may include: a first server, a terminal device having a user interface communicating to the first server, and a second server communicating to the first server; wherein:

The terminal device may be configured to: receive a subset of real-name information from a user interface, wherein the subset of the real-name information comprises at least a portion of: a user name or a user identification number, wherein the portion is associated with an electronic exchange account stored in the data storage of the first server;

The first server may be configured to: receive the subset of the real-name information from the terminal device, search the real-name information stored in the data storage with the subset of the real-name information, wherein the real-name information is pre-stored in the data storage; upon the real-name information is found in the first server, send the real-name information from the first server to the second server;

The second server may be configured to: upon the receipt of the real-name information, find whether the real-name information associates with a credit account that is stored in the second server, after finding the credit account is not stored in the second server, sending a credit indicator from the second server to the first server;

The first server may be configured to: after receiving the credit indicator, determine whether an exchange resource account tying to the electronic exchange account is stored in the data storage; if the exchange resource account tying the electronic exchange account is not stored in the data storage, send a binding instruction to the user interface of the terminal device;

The terminal device is configured to: according to the binding instruction, receive account information of a resource saving account from the user interface, and send the account information to the first server;

The first server is configured to: receive the account information of the resource saving account, and store the account information in the data storage, bind the electronic exchange account and the resource saving account, and send a binding result that results from binding the electronic exchange account and the resource saving account to the second server;

The second server is configured to: receive the binding result from the first sever, and create a virtual credit card account; and

The first server is configured to: store the virtual credit card associated with the virtual credit card account in the data storage of the first server.

The virtual credit card may be stored in the first server after the second server creates the virtual card account. The virtual credit card may be tied with the electronic account and/or the exchange resource account stored in the data storage of the first server. The first server may provide the cardholder means to access the card, such as an additional user interface to access the card via a terminal device. The access to the virtual credit card may be provided to the cardholder after the verification of the cardholder is passed. Any verification means, either currently known or later developed, may be used by the first server for such verification purpose. By this way, the user does not need to have a physical credit card.

In case the virtual credit card tied with the electronic exchange account stored in the data storage of the first server, the historical data stored or obtained by the first server may be used to verify the cardholder for the virtual credit card. In addition, the terminal device may be the cardholder's own mobile phone, the terminal device may provide built-in feature for the verification, such as fingerprint verification.

As such, the first server may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

The first server of the system may be configured to acquire user history data from the data storage according to the electronic exchange account, and send the user history data to the second server; and the second server may be configured to: receive the user history data, and create the virtual credit card account by using the user history data.

The second server of the system may be analyze the user history data by accessing at least one of: user payment data, user social data, historical email data, historical financing data and historical login data that are included in the user history data received; and determine the credit limit of the virtual credit card account according to the analyzed user history data.

The first server of the system may be configured to validate the terminal device wherein: the terminal device is configured to: receive a validation terminal identity from the user interface; the first server is configured to: receive the validation terminal identify from the terminal device, send validation information to a second user interface according to the received validation terminal identity; in response to send the validation information, receive second validation information to be validated from the terminal device; determine whether the second validation information matches the validation information; and validate the terminal device by saving an indicator in the data storage of the first server to indicate the terminal device is validated if the second validation information matches the validation information.

The first server of the system may be configured to validate the terminal device by using at least one of: SMS validation, instant messaging validation, voice validation, and email validation.

The second server of the system may be further configured to send virtual credit card account information to the first server; the first server is further configured to: receive the virtual credit card account information, bind the virtual credit card and the electronic exchange account; and send a second binding result that results from binding the electronic exchange account and the virtual credit card to be displayed in the user interface of the terminal device.

The terminal device of the system may be receive a second set of user information from the user interface; the first server is configured to: acquire the second set of the user information and send the acquired second set of information to the second server; the second server is configured to: increase the credit limit for the virtual credit card account stored in the second server; and the first server is configured to: attach the increased credit limit to the virtual credit card stored in the first server.

The first server of the system may be configured to: bind the virtual credit card stored in the data storage and the resource saving account, and display a notification in the user interface of the terminal device to notify that the virtual credit and the resource saving account are bound; and automatically transfer fund from the bound resource saving account to the virtual credit card stored in the first server when the virtual credit card is overdrawn.

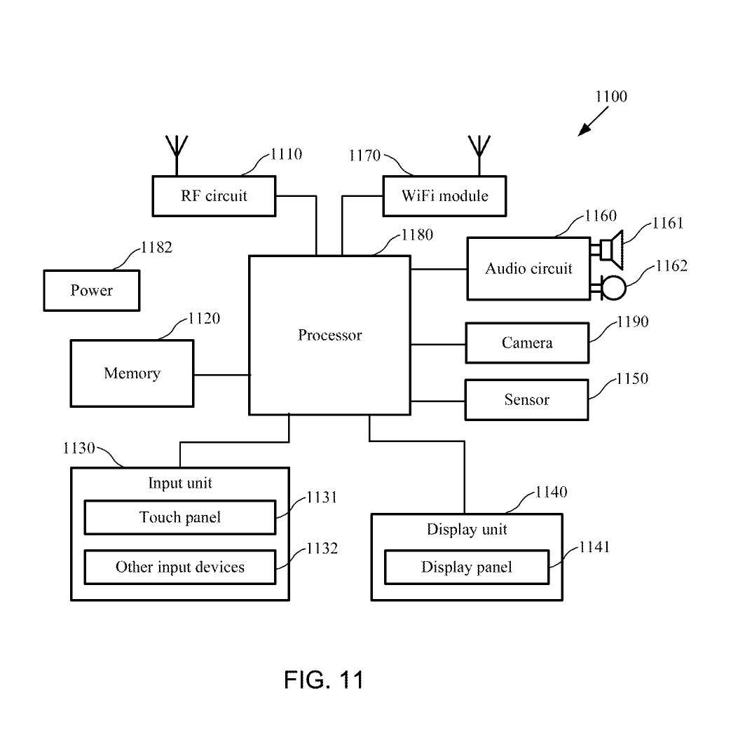

As shown in FIG. 11, it shows a frame diagram of terminal according to the example of present disclosure, the terminal is configured to implement the method for creating virtual credit card account according to the example of present disclosure, the terminal according to the example of present disclosure may include one or more following parts: a processor for executing computer program instructions to complete various processes and methods, a random access memory (RAM), and a read only memory (ROM) for information and storing program instructions, a memory for storing data and information, an I/O devices, an interface, an antenna, and so on. The detail is as follow.

The terminal 1100 may include a RF (Radio Frequency) circuit 1110, a memory 1120, an input unit 1130, a display unit 1140, a sensor 1150, an audio circuit 1160, a wife (wireless fidelity) module 1170, a processor 1180, power 1182, a camera 1190, and other parts. The person skilled in the art may understand that the structure of the terminal shown in FIG. 11 does not limit the terminal and may include more or fewer components than shown in FIG. 11, or a combination of some of the components, or a different arrangement of components.

The following describes various components of the terminal 1100 in detail with reference to the FIG. 11.

RF circuit 1110 may be used to receive and send message, or send and receive signals of during a call, in particular, receive and send the downlink message of the base station to the processor 1180 to process; further, send the uplink data of the design to the base station. Typically, RF circuit includes but not limited to antenna, at least one amplifier, transceiver, couplers, LNA (Low Noise Amplifier, LNA), diplexer, and so on. In addition, The RF circuit 1110 may also communicate with other devices via wireless communication and network. The wireless communication may use any communication Standards or protocols, including but not limited to GSM (Global System of Mobile communication), GPRS (General Packet Radio Service), CDMA (Code Division Multiple Access), WCDMA (wideband Code Division Multiple Access), LIE (Long Term Evolution), e-mail, SMS (Short Messaging Service), and so on.

Memory 1120 may be used to store software programs and modules, the processor 1180 executes various functions application and data processing of terminal 1100 by running software programs and modules in memory 1120. The memory 1120 may mainly include a storage program area and a storage date area, wherein the storage program area may store an operating system, the application required by at least one function (such as sound playback, image playback, etc.); The storage date area may store the data (such as audio data, phone book, etc.) created according to the usage of the terminal 1100. In addition, the memory 1120 may include high-speed random access memory, and may also include non-volatile memory, such as at least one disk storage device, flash memory device, or other easily Volatile solid-state memory devices.

An input unit 1130 may be used to receive inputted number or character information, and generate inputting key signal related to the user settings and function control of the terminal 1100. Specifically, the input unit 1130 may include a touch panel 1131, and other input devices 1132. The touch panel 1131, is also known as touch screen, may collect touch operations of the user on or near it (such as operations of user using finger, stylus and any other suitable object or attachment on or near the touch panel 1131), and drive the corresponding connecting device according to a preset program. Optionally, the touch panel 1131 may include a touch detection device and a touch controller. The touch detection device detects the position a user touches, detects and sends the signal brought by the touch operation to the touch controller; the touch controller receives touch information from the touch detecting device, and converts it into contact coordinates, and then sends the contact coordinates to the processor 1180, and may receive and execute commands sent by the processor 1180. Further, resistive, capacitive, infrared and surface acoustic wave, and many other types touch panel may be used to achieve the touch panel 1131. In addition to the touch panel 1131, the input unit 1130 may also include other input devices 1132. In detail, the other input devices 1132 may include but are not limited to one or more of the physical keyboard, function keys (such as volume control keys, key switches, etc.), the trackball, the mouse, the operating lever, and so on.

The display unit 1140 may be used to display information inputted by the user or information provided to the user and various menus of terminal 1100. The display unit 1140 may include a display panel 1141; optionally, LCD (Liquid Crystal Display), OLED (Organic Light-Emitting Diode), and other form may be used to configure the display panel 1141. Further, the touch panel 1131 may cover the display panel 1141, the touch panel 1131 sends the touch operations to the processor 1180 after detecting there are the touch operations existing on or near it, and then the processor 1180 provides corresponding visual output in the display panel 1141 according to the type of touch event. Although the touch panel 1131 and the display panel 1141 achieve the input and output functions of the terminal 1100 as two separate component shown in FIG. 11; in some examples, the touch panel 1131 and the display panel 1141 may be integrated together to achieve the input and output functions of the terminal 1100.

The terminal 1100 may further include at least one sensor 1150, such as a gyro sensor, magnetic sensors, optical sensors, motion sensors, and other sensors. In detail, the optical sensor may include ambient light sensor and proximity sensor, wherein the ambient light sensor may adjust the brightness of the display panel 1141 according to the brightness of the ambient light, the proximity sensor may close the display panel 1141 and/or backlight, when the terminal 1100 moves nearby the ears. As one type of the motion sensor, an acceleration sensor may detect the magnitude of acceleration of the respective directions (typically axis, in general), the direction and speed of gravity may be detected by the acceleration sensor when stationary, the acceleration sensor may be used to identify terminal posture applications (such as vertical screen switching, related games, magnetometer calibration posture), vibration to recognize related functions (such as pedometers, percussion), etc.; barometers, hygrometers, thermometers, infrared sensors, and other sensors may be configured to the terminal 1100, which will not be repeated here.

An audio circuit 1160, a speaker 1161, a microphone 1162 may provide audio interface between the user and the terminal 1100. The audio circuitry 1160 may send the electrical signal which is transformed from the received audio data by the audio circuitry 1160 to the speaker 1160, the speaker 1161 transforms the electrical signal into a sound signal, and outputs it; on the other hand, the microphone 1162 transforms the collected sound signal into a electrical signal, the audio circuit 1160 transforms the received electrical signal into audio data and outputs it to the processor 1180 to be processed, after processing by the processor 1180, the RF circuit 1110 sends it to the other terminal, or outputs audio data to the memory 1120 for further processing.

Wifi is a short-range wireless transmission technology, the terminal 1100 helps users send and receive email, browse the web, and access streaming media, and the like through Wifi module 1170; it provides users with wireless broadband Internet access. Although FIG. 11 shows a Wifi module 1170, it should be understood that it is not an integral part of the terminal 1100, it may be omitted as required within the scope which is not changing the essence of disclosure.

The processor 1180 is the control center of the terminal 1100, connects various parts of the terminal by using various interfaces and connections, executes various functions and processing data of the terminal 1100 by running or executing software program and/or module stored in the memory 1120 and by calling the data stored in the memory 1120, and thus monitor the terminal overall. Optionally, the processor 1180 may include one or more processing units; Preferably, the processor 1180 may integrated the application processor and the modem processor, wherein the application processor mainly process operating system, user interface, and applications program, and so on, the modem processor mainly process wireless communication. It should be understood that the above processor may also be not integrated into the processor 1180.

The terminal 1100 further includes a power supply 1182 (such as batteries) which supplies power to each part, preferably, the power supply may be connected logically with the processor 1180 through a power management system, and thus achieve functions of managing charging, discharging and power consumption through the power management system.

The camera 1190 is usually composed of camera lens, image sensor, interface, digital signal processor, CPU, display screen and so on. The camera lens is fixed at the top of the image sensor, it may change the focus by manually adjusting the camera lens; the image sensor is equivalent to the “film” of traditional camera, which is the heart of capturing images by the camera; the interface is used to connect the camera lens with the terminal motherboard by using cable, board to board connectors, a spring-type connection, send the collected images to the memory 1120; the digital signal processor processes the collected images through mathematical operations, transforms the collected simulated images into digital images and sends it to the memory 1120 through the interface.

Although not shown, the terminal 1100 may also include bluetooth module, and so on, which are not repeated here.

The terminal 1100 includes a memory and one or more modules in addition to one or more processors 1180, wherein one or more modules are stored in the memory, and are configured to be executed by one or more processors. The one or more above modules are used to execute method for creating virtual credit card account, the method for creating virtual credit card account is shown in FIG. 2 and corresponding example to the FIG. 2; and/or, the method for creating virtual credit card account is shown in FIG. 3A and corresponding example to the FIG. 3.

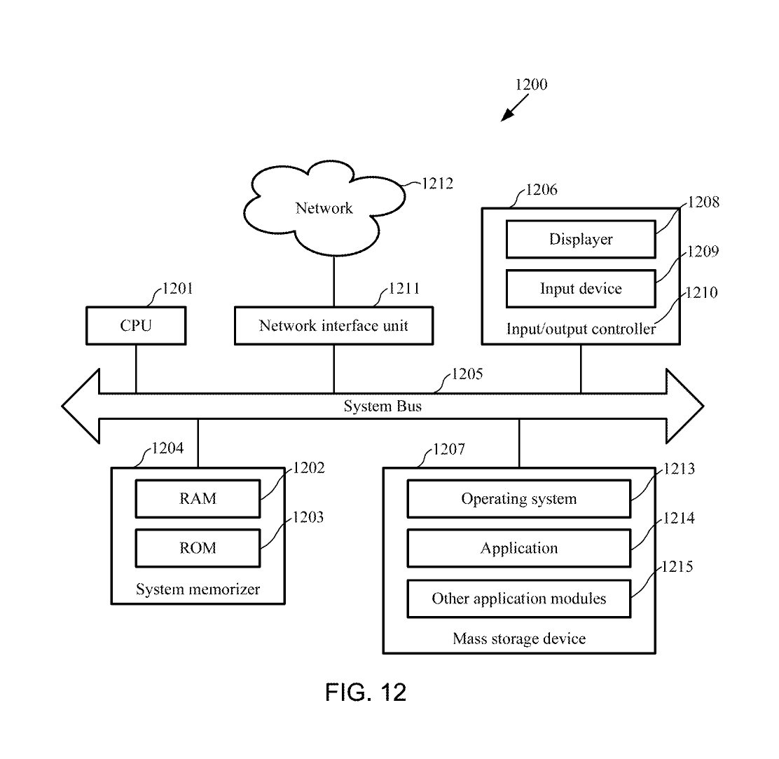

As shown in FIG. 12, it shows a structural schematic of a server according to an example of the present disclosure, the server may be the first server, may also be the second server. The server 1200 includes a central processing unit (CPU) 1201, a random access memory (RAM) 1202, and a system memory 1204 of read only memory (ROM) 1203, and a system bus 1205 connecting a system memory 1204 and the central processing unit 1201. The servers 1200 also include a basic input/output system 1206 (I/O system) for transferring information between the respective devices in the computer, an operating system 1213 for storing, application programs 1214 and a large capacity storage device 1207 of other modules 1215.

The said basic input/output system 1206 includes a displayer 1208 for displaying information, and an input device 1209 such as a mouse, a keyboard and other input devices for the user to input information. The display device 1208 and the input device 1209 are connected to the central processing unit 1201 by being connected to the input and output controller 1210 of the system bus 1205. The basic input/output system 1206 may also include the input and output controller 1210 to receive and process the input from the keyboard, the mouse, or the electronic stylus and other devices. Similarly, the input and output controller 1210 further provides outputting to the display, the printer, or other output devices.

The large capacity storage device 1207 is connected to the central processing unit 1201 by being connected to a mass storage controller (not shown) of the system bus 1205. The large capacity storage device 1207 and its associated computer readable medium provide nonvolatile storage for the server 1200. That is, the large capacity storage device 1207 may include computer readable medium such as a hard disk or CD-ROM drive (not shown).

In general, the computer readable medium may include computer storage medium and communication medium, either transitory or non-transitory. Computer storage medium includes any methods for storing information such as computer readable instructions, data structure, program modules or other data and other information or technical implementation volatile and nonvolatile, removable and non-removable medium. Computer storage medium includes RAM, ROM, EPROM, EEPROM, flash memory or other solid state memory technology, CD-ROM, DVD, or other optical storage, magnetic cassettes, magnetic tape, magnetic disk storage or other magnetic storage devices. Those persons skilled in the art may understand that the computer storage medium is not limited to the above types. The above-mentioned system memory 1204 and the large capacity storage device 1207 may be collectively called memory.

The server 1200 may also be connected to a remote computer on the network to run through network, such as the internet according to various examples of the present disclosure, That is, the server 1200 may be connected to the network 1212 by being connected to the network interface unit 1211 of the system bus 1205, or may be connected to other types of networks and remote computer system by using the network interface unit 1211 (not shown).

The memory further includes one or more than one programs, the one or more than one programs are stored in the memory, the one or more than one programs are used to execute the method for creating virtual credit card account, the method for creating virtual credit card account is shown in FIG. 2 and corresponding example to the FIG. 2; and/or, the method for creating virtual credit card account is shown in FIG. 3A and corresponding example to the FIG. 3.

It should be noted that when the device for creating virtual credit card account according to the above-mentioned examples is creating virtual credit card account, it only takes delineation of the above-mentioned functional modules for example to illustrate, in reality, the above-mentioned functions may be assigned to be completed by different functional modules as required, that is to divide the internal structure of the device for creating virtual credit card account into different functional modules to complete all or part of the functions described above. In addition, the device for creating virtual credit card account according to the above-mentioned examples and the method example for creating virtual credit card account belong to the same idea, and its specific implementation process is detailed in the method example and will not be repeated here.

The serial numbers of the examples of the present disclosure above-mentioned do not to represent the merits of the example, but only helps to describe.

Those person skilled in the art may clearly understand that some or all steps of the above-described examples may be achieved by hardware as well as instructing relevant hardware through procedure, the said procedure may be stored in computer readable storage medium, the above-mentioned storage medium may be a ROM, a disk, or a CD, etc.

The foregoing descriptions are merely exemplary examples of the present disclosure, but are not intended to limit the present disclosure. Any modifications, equivalent substitutions, and improvements made within the spirit and principle of the present disclosure shall fall within the protection scope of the present disclosure.

What is claimed is:

1. A device for creating a virtual credit card comprising: a first server having a data storage containing real-name information associated with an electronic exchange account;
wherein the first server is configured to:
receive a subset of real-name information from a user interface of a terminal device wherein the subset of the real-name information includes at least a portion of a user name or user identification number, wherein the portion is associated with the electronic exchange account;
search for the real-name information stored in the data storage using the received subset of the real-name information;
send the real-name information found in the data storage to the second server for use in finding an associated credit card account stored in the second server;
receive a credit indicator from the second server if the credit card account is not stored in the second server;
determine, upon receipt of the credit indicator, whether an exchange resource account associated with the electronic exchange account is stored in the data storage;
send, upon receipt of a determination that the exchange resource account is not stored in the data storage, a binding instruction to the user interface of the terminal device;
receive, according to the binding instruction, account information of a resource saving account from the user interface of the terminal device;
store the account information to the data storage;
bind the electronic exchange account and the resource saving account;
send a binding result to the second server;
receive information associated with a virtual credit card account created by the second sever after receiving the binding result; and
store the virtual credit card associated with the virtual credit card account in the data storage of the first server.

2. The device of claim 1, wherein the first server is configured to:
acquire user history data according to the electronic exchange account, and send the user history data to the second server wherein the user history data is used to create the virtual credit card account.

3. The device of claim 1, wherein the first server is configured to validate the terminal device before binding the electronic exchange account and the resource saving account, wherein the first server is further configured to:
receive a validation terminal identity from the user interface of the terminal device;
send validation information to a second user interface according to the validation terminal identity received by the first server;
in response to send the validation information, receive second validation information to be validated from the terminal device;
determine whether the second validation information matches the validation information; and
validate the terminal device by saving an indicator in the data storage to indicate the terminal device is validated if the second validation information matches the validation information.

4. The device of 3, wherein the first server is configured to:
validate the terminal device by using at least one of: SMS validation, instant messaging validation, voice validation, and email validation.

5. The device of claim 1, wherein the first server is configured to:
receive the virtual credit card account information from the second server, bind the virtual credit card and the electronic exchange account; and
send a second binding result that results from binding the electronic exchange account and the virtual credit card to be displayed in the user interface of the terminal device.

6. The device of claim 5, wherein the first server is configured to:
receive a second set of user information from the user interface of the terminal device;
send the received second set of information to the second server, wherein the second set of information is used for increasing the credit limit for the virtual credit card account stored in the second server; and
attach the increased credit limit to the virtual credit card stored in the first server.

7. The device of claim 5, wherein the first server is configured to:
bind the virtual credit card and the resource saving account stored in the data storage, and display a notification in the user interface of the terminal device to notify that the virtual credit and the resource saving account are bound; and
automatically transfer fund from the bound resource saving account to the virtual credit card stored in the first server when the virtual credit card is overdrawn.

8. A system for creating virtual credit to be stored in a data storage, comprising: a first server, a terminal device having a user interface communicating to the first server, and a second server communicating to the first server;
wherein the terminal device is configured to:
receive a subset of real-name information from a user interface, wherein the subset of the real-name information comprises at least a portion of: a user name or a user identification number, wherein the portion is associated with an electronic exchange account stored in the data storage of the first server;
wherein the first server is configured to:
receive the subset of the real-name information from the terminal device,
search the real-name information stored in the data storage with the subset of the real-name information, wherein the real-name information is pre-stored in the data storage;
upon the real-name information is found in the first server, send the real-name information from the first server to the second server;
wherein the second server is configured to:
upon the receipt of the real-name information, find whether the real-name information associates with a credit card account that is stored in the second server,
after finding the credit card account is not stored in the second server, sending a credit indicator from the second server to the first server;
wherein the first server is configured to:
after receiving the credit indicator, determine whether an exchange resource account tying to the electronic exchange account is stored in the data storage;
if the exchange resource account tying the electronic exchange account is not stored in the data storage, send a binding instruction to the user interface of the terminal device;
wherein the terminal device is configured to:
according to the binding instruction, receive account information of a resource saving account from the user interface, and send the account information to the first server;
wherein the first server is configured to:
receive the account information of the resource saving account, and store the account information in the data storage, bind the electronic exchange account and the resource saving account, and send a binding result that results from binding the electronic exchange account and the resource saving account to the second server;
wherein the second server is configured to:
receive the binding result from the first sever, and create a virtual credit card account; and
wherein the first server is configured to:
store the virtual credit card associated with the virtual credit card account in the data storage of the first server.

9. The system of claim 8, wherein:
the first server is configured to:
acquire user history data from the data storage according to the electronic exchange account, and send the user history data to the second server; and
the second server is configured to:
receive the user history data, and create the virtual credit card account by using the user history data.

10. The system of claim 9, wherein the second server is configured to:
analyze the user history data by accessing at least one of: user payment data, user social data, historical email data, historical financing data and historical login data that are included in the user history data received; and
determine the credit limit of the virtual credit card account according to the analyzed user history data.

11. The system of claim 8, wherein the first server is configured to validate the terminal device wherein:
the terminal device is configured to:
receive a validation terminal identity from the user interface;
the first server is configured to:
receive the validation terminal identify from the terminal device, send validation information to a second user interface according to the received validation terminal identity;
in response to send the validation information, receive second validation information to be validated from the terminal device;
determine whether the second validation information matches the validation information; and
validate the terminal device by saving an indicator in the data storage of the first server to indicate the terminal device is validated if the second validation information matches the validation information.

12. The system of 11, wherein the first server is configured to validate the terminal device by using at least one of: SMS validation, instant messaging validation, voice validation, and email validation.

13. A method for creating a virtual credit card to be stored in a data storage, comprising:
receiving a subset of real-name information from a user interface by a terminal device, wherein the subset of the real-name information comprises at least a portion of: a user name or a user identification number, wherein the portion is associated with an electronic exchange account stored in the data storage of a first server;
receiving, by the first server, the subset of the real-name information;
searching the real-name information stored in the first server with the subset of the real-name information, wherein the real-name information is pre-stored in the data storage of the first server;
upon the real-name information is found in the first server, sending the real-name information from the first server to the second server, and finding, by the second server, whether the real-name information associates with a credit card account stored in the second server;
after finding the credit card account is not stored in the second server, sending a credit indicator from the second server to the first server;
determining, by the first server, whether an exchange resource account tying to the electronic exchange account is stored in the first server after the credit indicator is received by the first server;
if the exchange resource account tying to the electronic exchange account is not stored in the first server, sending, by the first server, a binding instruction to the user interface of the terminal device;
according to the binding instruction, receiving account information of a resource saving account from the user interface of the terminal device, and sending, by the terminal device, the account information to the first server;
receiving, by the first server, the account information of the resource saving account, and storing the account information in the first server, binding the electronic exchange account and the resource saving account, and sending a binding result that results from binding the electronic exchange account and the resource saving account to the second server;
receiving, by the second server, the binding result from the first sever, and creating a virtual credit card account; and
storing the virtual credit card associated with the virtual credit card account in the data storage of the first server.

14. The method of claim 13, before creating the virtual credit card account, further comprising:
acquiring user history data stored in the data storage of the first server according to the electronic exchange account, and sending the user history data to the second server; and
receiving the user history data by the second server, and creating the virtual credit card account by using the user history data.

15. The method of claim 14, wherein creating the virtual credit card account by using the user history data comprises:
analyzing the user history data by accessing at least one of: user payment data, user social data, historical email data, historical financing data and historical login data that are included in the user history data received by the second server; and
determining, by the second server, the credit limit of the virtual credit card account according to the analyzed user history data.

16. The method of claim 13, before binding the electronic exchange account and the resource saving account, further comprising: validating the terminal device by the first server, wherein validating the terminal device comprises:
receiving, by the first server, a validation terminal identity from the user interface of the terminal device;
sending validation information to a second user interface according to the validation terminal identity received by the first server;
in response to sending the validation information, receiving second validation information to be validated from the terminal device;
determining whether the second validation information matches the validation information; and
validating the terminal device by saving an indicator in the data storage of the first server to indicate the terminal device is validated if the second validation information matches the validation information.

17. The method of 16, wherein validating the terminal device by the first server further comprises:
validating the terminal device by using at least one of: SMS validation, instant messaging validation, voice validation, and email validation.

18. The method of claim 13, after creating the virtual credit card account, further comprising:
sending, by the second server, virtual credit card account information to the first server;
receiving, by the first server, the virtual credit card account information, binding the virtual credit card and the electronic exchange account; and
sending, by the first server, a second binding result that results from binding the electronic exchange account and the virtual credit card to be displayed in the user interface of the terminal device.

19. The method of claim 18, after sending the second binding result to the user interface, further comprising:
receiving a second set of user information from the user interface of the terminal device;
acquiring, by the first server, the second set of the user information and sending the acquired second set of information to the second server;
increasing, by the second server, the credit limit for the virtual credit card account stored in the second server; and
attaching the increased credit limit to the virtual credit card stored in the first server.

20. The method of claim 18, after receiving the virtual credit card account information, further comprising:
binding, by the first server, the virtual credit card and the resource saving account stored in the first server, and displaying a notification in the user interface of the terminal device to notify that the virtual credit and the resource saving account are bound; and
automatically transferring, by the first server, fund from the bound resource saving account to the virtual credit card stored in the first server when the virtual credit card is overdrawn.
